(19) United States
(12) Patent Application Publication
(10) Pub. No.: US 2013/0070577 A1
(43) Pub. Date: Mar. 21, 2013

(54) OPTICAL RECORDING MEDIUM, RECORDING APPARATUS, RECORDING METHOD

(71) Applicants: Yoshinori Suzuki, Kanagawa (JP); Kazuhiko Fujiie, Kanagawa (JP); Koji Sekiguchi, Kanagawa (JP)

(72) Inventors: Yoshinori Suzuki, Kanagawa (JP); Kazuhiko Fujiie, Kanagawa (JP); Koji Sekiguchi, Kanagawa (JP)

(73) Assignee: SONY CORPORATION, Tokyo (JP)

(21) Appl. No.: 13/607,085

(22) Filed: Sep. 7, 2012

(30) Foreign Application Priority Data
Sep. 15, 2011 (JP) 2011-201772

(51) Int. Cl. G11B 7/00; G11B 7/085; G11B 7/24

(52) U.S. Cl. 369/30.03; 369/275.4; 369/44.11; G9B/7.139; G9B/7.042; G9B/7

(57) ABSTRACT

Provided is an optical recording medium, including a plurality of tracks on each of which small record carriers are arranged in a wobbling manner, each of the small record carriers storing a recording state by modulation according to light irradiation, wherein the tracks are arranged adjacent to each other in a tracking direction which is a direction orthogonal to a longitudinal direction of the tracks, and there is a reflectance difference between a forming portion and a non-forming portion of the small record carrier in both of a recording state and a non-recording state of the small record carrier.

### CROSS REFERENCES TO RELATED APPLICATIONS

The present application claims priority to Japanese Priority Patent Application JP 2011-201772 filed in the Japan Patent Office on Sep. 15, 2011, the entire content of which is hereby incorporated by reference.

### BACKGROUND

The present application relates to an optical recording medium used as a pattern medium in which a track on which a plurality of small record carriers in which a recording state is maintained by modulation according to irradiation of light are arranged is formed, and recording information is expressed by a record/non-record pattern of the small record carrier on the track.

Further, the present application relates to a recording apparatus and method which perform recording on an optical recording medium used as a pattern medium.

For example, a so-called optical disc recording medium (which may also be referred to simply as an “optical disc”) such as a compact disc (CD), a digital versatile disc (DVD), and a Blu-ray disc (BD) (a registered trademark) has widely been spread as an optical recording medium that records and reproduces information by irradiation of light.

On optical discs, a reduction in a wavelength of recording/reproducing light and an increase in a numerical aperture of an objective lens are being made. Thus, a beam spot size for recording/reproducing is reduced, leading to a high recording capacity and high recording density.

However, in optical discs, air is used as a medium between an objective lens and the optical disc, and it is difficult to increase the numerical aperture NA having influence on the size (diameter) of a focus spot to be larger than “1.”

Specifically, when a numerical aperture of an objective lens is NA_{obj}, and a wavelength of light is λ, the size of a spot of light that irradiates onto an optical disc through an objective lens is expressed as follows:

λ/NA_{obj}

At this time, when a refractive index of a medium interposed between the objective lens and the optical disc is n_{A}, and an incident angle of a light beam around the objective lens is θ, the numerical aperture NA_{obj} is expressed as follows:

NA_{obj}=n_{A}×sin θ

As can be seen from this formula, it is difficult to increase the numerical aperture NA_{obj} to be larger than 1 as long as a medium is air (n_{A}=1).

In this regard, recording/reproducing methods (a near field method) that implement NA_{obj}>1 using near-field light (evanescent light) have been proposed as disclosed in Japanese Patent Application Laid-Open (JP-A) No. 2010-33688, Japanese Patent Application Laid-Open (JP-A) No. 2009-134780, and the like.

This near field method is known to record or reproduce information by irradiating an optical disc with near-field light, and a solid immersion lens (hereinafter referred to as a “SIL”) is used as an objective lens used to irradiate the optical disc with near-field light (for example, see JP-A No. 2010-33688 and JP-A No. 2009-134780).

FIG. 20 is a diagram to describe a near field optical system of a related art using an SIL.

FIG. 20 illustrates an example in which an SIL of a super hemispherical shape (super hemispherical SIL) is used as an SIL. Specifically, in the super hemispherical SIL in this case, an object side (that is, a side facing a recording medium which is a recording/reproducing target) has a planar shape, and the other portions have a super hemispherical shape.

In this case, an objective lens is configured as a two-group lens including the super hemispherical SIL as a front lens. As shown in FIG. 17, a double-sided aspherical lens is used as a rear lens.

Here, when an incident angle of incident light is θi, and a refractive index of a constitutional material of the super hemispherical SIL is n_{SIL}, an effective numerical aperture NA of the objective lens having the configuration illustrated in FIG. 20 is expressed as follows:

NA=n_{SIL}×sin θi

Through this formula, when the configuration of the objective lens illustrated in FIG. 20 is employed, the effective numerical aperture NA can be larger than “1” by setting the refractive index n_{SIL} of the SIL to be larger than “1” (larger than a refractive index of air).

In the related arts, for example, the refractive index n_{SIL} of the SIL is set at about 2, and thus the effective numerical aperture NA of about 1.8 is implemented.

Here, in the near field optical system, an SIL of a hemispherical shape (hemispherical SIL) as well as the super hemispherical SIL is used.

When the hemispherical SIL is used for the objective lens instead of the super hemispherical SIL illustrated in FIG. 17, an effective numerical aperture NA is as follows:

NA=n_{SIL}×sin θi

Through this formula, even when the hemispherical SIL is used, when a high refractive index material of n_{SIL} is used as a constitutional material of an SIL, NA>1 can be implemented.

At this time, compared with the formula in the case of the super hemispherical SIL, when the constitutional material (refractive index) of the SIL is the same in both of the case of the super hemispherical shape and the hemispherical shape, the effective numerical aperture NA in the case of using the super hemispherical SIL is higher.

For the sake of confirmation, in order to perform recording/reproducing propagating (irradiating) light of NA>1 generated by the SIL to a recording medium, it is necessary to arrange an object plane of the SIL and the recording medium to be very close to each other. A distance between an objective surface of the SIL and the recording medium (recording surface) is called a gap.

In the near field method, it is necessary to suppress a gap value to be equal to or less than at least a fourth (¼) a wavelength of light.

Meanwhile, in the related arts, studies on the structure of a recording medium have been conducted in order to implement high recording density. For example, a pattern medium has been known as disclosed in Japanese Patent Application Laid-Open (JP-A) No. 2010-27169.

The pattern medium is a medium in which a plurality of small record carriers are arranged, and one small record carrier functions as one code (“0” or “1”). For example, a non-recording state is represented by a code “0,” and a recording state is represented by a code “1.”

Since the small record carriers are independently formed, even when the small record carriers are arranged to be close to one another, that is, even when the small record carriers are arranged with high density, cross light or crosstalk can be suppressed. In other words, the recording density can be increased accordingly.

JP-A No. 2010-27169 discloses a hard disk drive (HDD) recording/reproducing system employing a pattern medium. However, the recording/reproducing system for the pattern medium according to the related art employs a so-called sector servo method (sample servo method) as disclosed in JP-A No. 2010-27169.

Specifically, as illustrated in FIG. 3 of JP-A No. 2010-27169, small record carriers are arranged on a recording medium such that a servo pattern region S is inserted between data recording regions D used for recording/reproducing data, and the position of a recording/reproducing head is intermittently controlled using a record pattern in the servo pattern region S.

Here, in the pattern medium recording/reproducing system of the related art employing the sector servo method, a pattern to generate a pattern or a clock representing address information is embedded in the servo pattern region S. In other words, this pattern is used to perform address detection, rotation synchronization (rotating speed control) of a disk, generation of a dot clock, and the like.

The dot clock refers to a clock which is synchronized with a forming period of the small record carrier, and is a clock necessary to appropriately apply a recording pulse at a timing corresponding to the forming position of the small record carrier. Thus, in the pattern medium, the dot clock is necessarily generated to implement an appropriate recording operation.

Magnetic recording media based on the pattern medium have already been developed, and optical recording media based on the pattern medium have been proposed. For example, an optical recording medium is disclosed in Japanese Patent Application Laid-Open (JP-A) No. 2006-73087.

When recording or reproducing is performed on a pattern medium serving as an optical recording medium, it is desirable to employ a near field method.

This is because when a near field method is used, as the optical spot size of recording/reproducing is reduced, the density of the small record carriers arranged on the pattern medium increases, and thus the recording capacity can be further increased.

### SUMMARY

Meanwhile, as described above, in the system of the related art that performs recording/reproducing on the pattern medium, the sector servo method is employed for a tracking servo (adjustment of the head position). However, as can be understood from the above description, the sector servo method employs a medium structure in which the servo pattern region S is inserted between the data recording regions D.

This means that, as the servo pattern region S is inserted, the data recording region D is reduced, and thus the sector servo method has a problem in that it causes a reduction in the recording capacity.

Further, in the sector servo method, since a tracking position is controlled based on discretely obtained tracking error signals, a servo tracking range is limited, and it is very difficult to increase a servo gain.

For this reason, an allowable range of disk eccentricity is small, and it is difficult to stably perform the tracking servo unless eccentricity is mechanically adjusted to be very small (for example, about several micrometers (μm)). The mechanical adjustment can be implemented in a system in which a recording medium (platter) is not exchangeable such as an HDD. However, it is realistically difficult to perform the precise adjustment in a system in which a recording medium is exchangeable.

The present application is made in light of the forgoing, and it is desirable to provide a preferred medium structure and a recording technique when recording is performed on a pattern medium serving as an optical recording medium.

In order to solve the above problems, an optical recording medium according to the present application employs the following configuration.

That is, according to an embodiment of the present application, there is provided an optical recording medium which includes a plurality of tracks on each of which small record carriers are arranged in a wobbling manner, each of the small record carriers storing a recording state by modulation according to light irradiation, wherein the tracks are arranged adjacent to each other in a tracking direction which is a direction orthogonal to a longitudinal direction of the tracks, and there is a reflectance difference between a forming portion and a non-forming portion of the small record carrier in both of a recording state and a non-recording state of the small record carrier.

Further, a recording apparatus according to the present application employs the following configuration.

That is, according to another embodiment of the present application, there is provided a recording apparatus which is a recording apparatus that performs recording on an optical recording medium that includes a plurality of tracks on each of which small record carriers are arranged in a wobbling manner, each of the small record carriers storing a recording state by modulation according to light irradiation, wherein the tracks are arranged adjacent to each other in a tracking direction which is a direction orthogonal to a longitudinal direction of the tracks, and there is a reflectance difference between a forming portion and a non-forming portion of the small record carrier in both of a recording state and a non-recording state of the small record carrier, and includes a light irradiating/receiving unit that is configured to irradiate recording light and reproducing light to the optical recording medium through an objective lens and to receive reflected light from the optical recording medium.

The recording apparatus further includes a tracking servo control unit that generates, based on a light receiving signal obtained by the light irradiating/receiving unit, a tracking error signal representing a position error of an optical spot formed on the optical recording medium by light irradiation by the light irradiating/receiving unit with respect to the track in the tracking direction, and controls a position of the objective lens in the tracking direction based on the tracking error signal.

The recording apparatus further includes an address information detecting unit that detects address information recorded by modulation of a wobbling frequency of the track, based on the light receiving signal.

The recording apparatus further includes a clock generating unit that generates a clock synchronized with a forming period of the small record carrier based on the light receiving signal.

The recording apparatus further includes a control unit that performs control such that the reproducing light is irradiated to the light irradiating/receiving unit in a preceding section before a section of a recording target on the track, a phase of the clock generated by the clock generating unit is then held to obtain a recording clock, and recording is performed on the small record carrier in the section of the recording target at a timing according to the recording clock.

As described above, in the optical recording medium according to the present application, a reflectance difference is given between the small record carrier and the remaining portion. Thus, even at the time of recording in which the small record carriers are in the non-recording state, the tracking error signal can be generated in the region in which the small record carriers are arranged.

Here, in the pattern medium which has been proposed in an HDD of the related art, it is difficult to obtain a signal amplitude difference between the small record carrier portion and the remaining portion in the data recording region in which the small record carriers are arranged, particularly, at the time of recording in which the small record carrier is in the non-recording state, and thus it is difficult to perform generation of the tracking error signal (the tracking servo) using the small record carrier in the data recording region at the time of recording. For this reason, the servo pattern region is inserted between the data recording regions, and a sector servo (a sample servo) using the servo pattern region is performed.

On the other hand, according to the present application in which the reflectance difference is given between the small record carrier and the remaining portion, even when the small record carrier is in the non-recording state (that is, even at the time of recording), the tracking error signal can be generated in the region in which the small record carriers are arranged. In other words, the tracking error signal can be generated without inserting the servo pattern region other than in the data recording region. Thus, continuous tracking servo control, rather than intermittent servo control such as the sector servo method, can be implemented in the region (data recording region) in which the small record carriers are arranged.

As described above, continuous servo control can be performed rather than intermittent servo control, the servo tracking range is larger than in the related art employing the sector servo method, and the servo gain can be easily increased. As a result, followability of eccentricity is improved, and stable tracking servo can be implemented with no particular need for the mechanical adjustment.

Further, in the present embodiment, the track on which the small record carriers are arranged remains wobbled. Thus, it is possible to continuously detect information recorded by wobbling, particularly, address information and like. In other words, when the sector servo method of the related art is employed, the signal amplitude difference is not obtained between the forming portion and the non-forming portion of the small record carrier in the data recording region, and thus detection of the address information and the like is intermittently performed using the servo pattern region. However, according to the present embodiment, the address information and the like can be continuously detected in the region in which the small record carriers are arranged.

Meanwhile, when recording is performed on the pattern medium, in order to accurately apply the recording pulse at the forming position of the small record carrier, a clock (dot clock) synchronized with the forming period of the small record carriers is generated, and it is necessary to apply the recording pulse at a timing according to the clock.

In the system employing the sector servo method of the related art, generation of the clock is performed by inserting the servo pattern region in which the record pattern for generation of the clock is formed between the data recording regions. In other words, phase synchronization of a clock is performed using the pattern formed in the servo pattern region, and recording on the data recording region is performed using the clock which has been subjected to the phase synchronization.

However, insertion of the servo pattern region causes a reduction in the recording capacity as described above.

Here, when the servo pattern region is not inserted, regions (data recording regions) in which the small record carriers are arranged are consecutive in the track. Thus, in this case, the clock needs to be generated in the region in which the small record carriers are arranged. However, at this time, when optical recording is performed as in the present application, it is very difficult to generate the clock using the reflected light of the recording light at the time of recording (since a quantity of reflected light is excessive). Thus, it is not realistic to generate the clock in the region in which the small record carriers are arranged during recording.

In this regard, in the present embodiment, employed is a technique of obtaining a recording clock by holding a phase of a clock generated by irradiation of reproducing light in a preceding section before a recording target section on a track and then performing recording on the recording target based on the recording clock. In other words, so-called running to generate the recording clock is performed in the preceding section before the recording target section.

At this time, a section in which recording of data has been completed is used as the preceding section before the recording target section. In other words, a section in which the small record carriers of the recording state are mixed with the small record carriers of the non-recording state is used as the preceding section before the recording target section. In this case, if a reflected light level of a small record carrier of the recording state (or a small record carrier of the non-recording state) is identical to a reflected light level of a portion in which the small record carrier is not formed, even when the running is performed using the section in which recording of data has been performed as the preceding section, it is difficult to detect an edge timing of each small record carrier, and thus it is difficult to acquire the accurate recording clock.

In light of this point, in the present embodiment, the optical recording medium is configured such that there is a reflectance difference between the forming portion and the non-forming portion of the small record carrier in both of the recording/non-recording states of the small record carrier. As a result, regardless of whether the small record carrier is in the recording state or the non-recording state, the edge timing of the small record carrier can be detected, and thus the accurate recording clock can be generated even when the section in which recording of data has been performed is used as the preceding section in which the running is performed. In other words, from this point of view, it is unnecessary to perform insertion of the servo pattern region, which needs to be performed in the sector servo method of the related art.

According to the embodiments of the present application described above, it is unnecessary to perform insertion of the servo pattern region, which needs to be performed in the pattern medium of the related art. Thus, the recording capacity can be increased to be larger than the related art.

Further, according to the embodiments of the present application described above, continuous tracking servo can be performed, and tracking servo can be implemented more stably than in the related art employing the sector servo method.

Further, according to the embodiments of the present application described above, even though the servo pattern region is not provided, for example, detection of the address information recorded by wobbling of the track can be continuously performed in the region in which the small record carriers are arranged.

Further, according to the embodiments of the present application described above, it is possible to provide a preferred medium structure and recording technique when recording is performed on a pattern medium serving as an optical recording medium.

Additional features and advantages are described herein, and will be apparent from the following Detailed Description and the figures.

### BRIEF DESCRIPTION OF THE FIGURES

FIG. 1 is a diagram for describing a structure of a recording surface of an optical recording medium according to an embodiment;

FIG. 2 is a plane view illustrating the entire structure of a recording surface of an optical recording medium according to an embodiment;

FIG. 3 is a diagram for describing a configuration of an objective lens according to an embodiment;

FIG. 4 is an enlarged cross-sectional view of a hyper lens portion;

FIG. 5 is a diagram for describing an outline of a recording/reproducing technique for an optical disc D;

FIG. 6 is a diagram for describing a recording technique according to the present embodiment;

FIG. 7 is a diagram for describing a technique of generating a dot clock in a running section;

FIG. 8 is a diagram illustrating an internal configuration of an optical pickup of a recording/reproducing apparatus according to an embodiment;

FIG. 9 is a diagram illustrating an overall internal configuration of a recording/reproducing apparatus according to an embodiment;

FIG. 10 is a diagram for describing a relation between a gap length and a quantity of return light from an objective lens;

FIG. 11 is a diagram for describing an internal configuration of a signal generating circuit;

FIG. 12 is a diagram for describing an internal configuration of a PLL circuit;

FIG. 13 is a diagram for describing an internal configuration of a recording processing unit;

FIG. 14 is a diagram illustrating a timing chart when a recording signal is generated;

FIG. 15 is a flowchart illustrating a procedure of a concrete process executed to implement a recording technique according to an embodiment;

FIG. 16 is a diagram for describing moving image data;

FIG. 17 is a diagram schematically illustrating an assignment of recording data in a recording format according to an embodiment;

FIG. 18 is a diagram for describing a modified embodiment in which an optical recording medium has a card-like external shape;

FIG. 19 is a diagram for describing a recording technique according to a modified embodiment; and

FIG. 20 is a diagram for describing a near field optical system using an SIL.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, an embodiment of the present disclosure will be described.

The description will proceed in the following order:

<1. Concrete Example of Optical Recording Medium>

<2. Recording/Reproducing Technique on Optical Recording Medium>

[2-1. Technique of Forming Small Optical Spot]

[2-2. Concrete Recording/Reproducing Technique]

<3. Recording/Reproducing Apparatus>

[3-1. Configuration of Optical Pickup]

[3-2. Internal Configuration of Whole Recording/Reproducing Apparatus]

[3-3. Example of Concrete Data Recording Format]<4. Modified Embodiment>

### <1. Concrete Example of Optical Recording Medium>

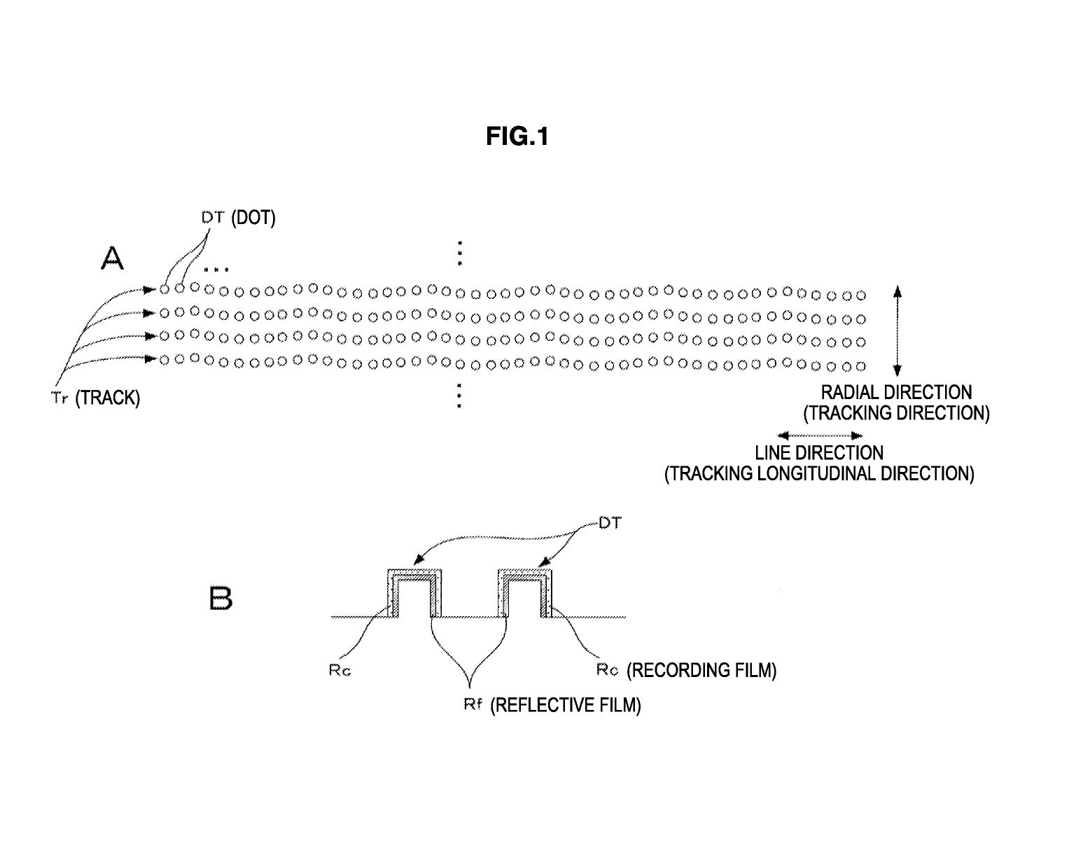

FIG. 1 is a diagram to describe the structure of a recording surface of an optical disc D as an embodiment of an optical recording medium of the present application. FIG. 1A is an enlarged plane view illustrating a part of the structure of the recording surface of the optical disc D, and FIG. 1B illustrates a cross-sectional structure of a part of the recording surface.

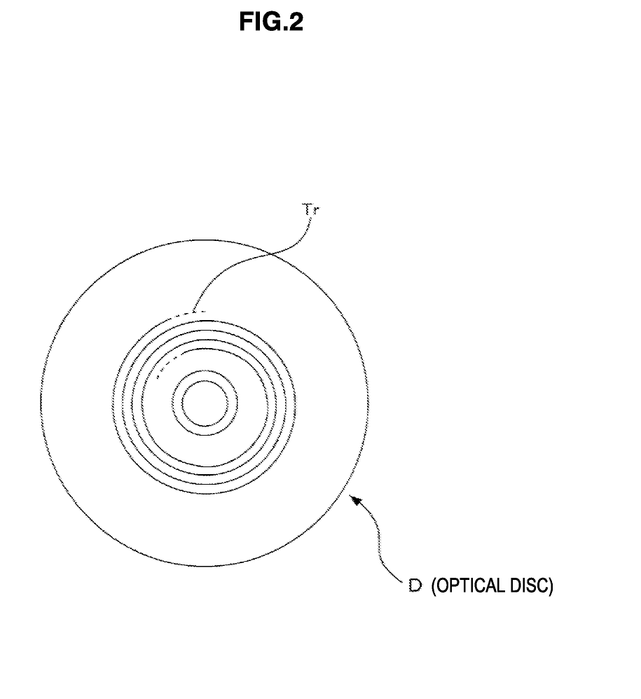

FIG. 2 is a plane view illustrating the entire recording surface of the optical disc D.

As can be seen from FIG. 2, a disc-shaped optical recording medium is used as the optical disc D of this example. The optical recording medium refers to a recording medium in which recording of a signal or reproducing of recording information is performed by irradiation of light.

The optical disc D of this example has the structure of the pattern medium.

For example, the pattern medium refers to a recording medium in which a track on which a plurality of small record carriers by the size of about several tens of nanometers (nm) or less are arranged is formed, and recording information is expressed by a record/non-record (including erasing) pattern of the small record carrier on the track.

The optical disc D of the present embodiment is an optical recording medium, and thus the small record carrier is configured to be modulated according to irradiation of light and hold a record state.

In FIG. 1A, dots DT are very densely arranged as small record carriers on the recording surface of the optical disc D.

As can be seen from FIGS. 1A and 1B, the dots DT in this case have circular cylindrical shapes.

As illustrated in FIG. 1B, each of the dots DT is configured to include a reflective film Rf and a recording film Rc formed on the surface. Through this structure, the dots DT are subjected to modulation according to irradiation of light and hold a record state.

Preferably, the recording film Rc is configured with a recording film made of an inorganic material or an organic material used in a write-once type optical disc, a phase change material used in a rewritable type optical disc, or the like.

As illustrated in FIG. 1A, a track Tr on which dots DT which are small record carriers are arranged in a wobbling manner is formed on a recording surface of the optical disc D.

The track Tr is formed in a spiral form on the recording surface of the optical disc as illustrated in FIG. 2. In this way, a plurality of tracks Tr are arranged to be adjacent to each other in a radial direction (tracking direction) of the optical disc D as illustrated in FIG. 1A.

Here, a direction which is orthogonal to the radial direction (tracking direction) and parallel to the longitudinal direction of the track Tr is referred to as a “line direction” as illustrated in FIG. 1A.

In the optical disc D according to the present embodiment, address information is recorded by wobbling of the track Tr. In other words, address information is recorded by modulation of a wobbling frequency of the track Tr.

Further, in the optical disc D, a forming pitch of the dots DT in the line direction is constant. The dots DT are formed to have the same size as each other.

For example, in the present embodiment, each of the dots DT is a convex cylinder (or a concave cylinder) of about 10 nm and has a diameter of about 11 nm. The forming pitch of the dots DT in the line direction is about 22 nm.

In the present embodiment, a forming pitch of the track Tr is constant, and for example, in this case, the forming pitch of the track Tr is about 22 nm.

Further, in the optical disc D, the wobbling frequency (the central frequency) of the track Tr is set to be 1/n (n is a natural number of 2 or more) of the forming period of the dots DT (that is, the frequency of a dot clock Dclk which will be described later). Specifically, in this case, the wobbling frequency of the track Tr is assumed to be set to about a several tenths the forming period of the dots DT.

### <2. Recording/Reproducing Technique on Optical Recording Medium>

[2-1. Technique of Forming Small Optical Spot]

As described above, in the optical disc D of the present embodiment, the dots DT are very densely arranged.

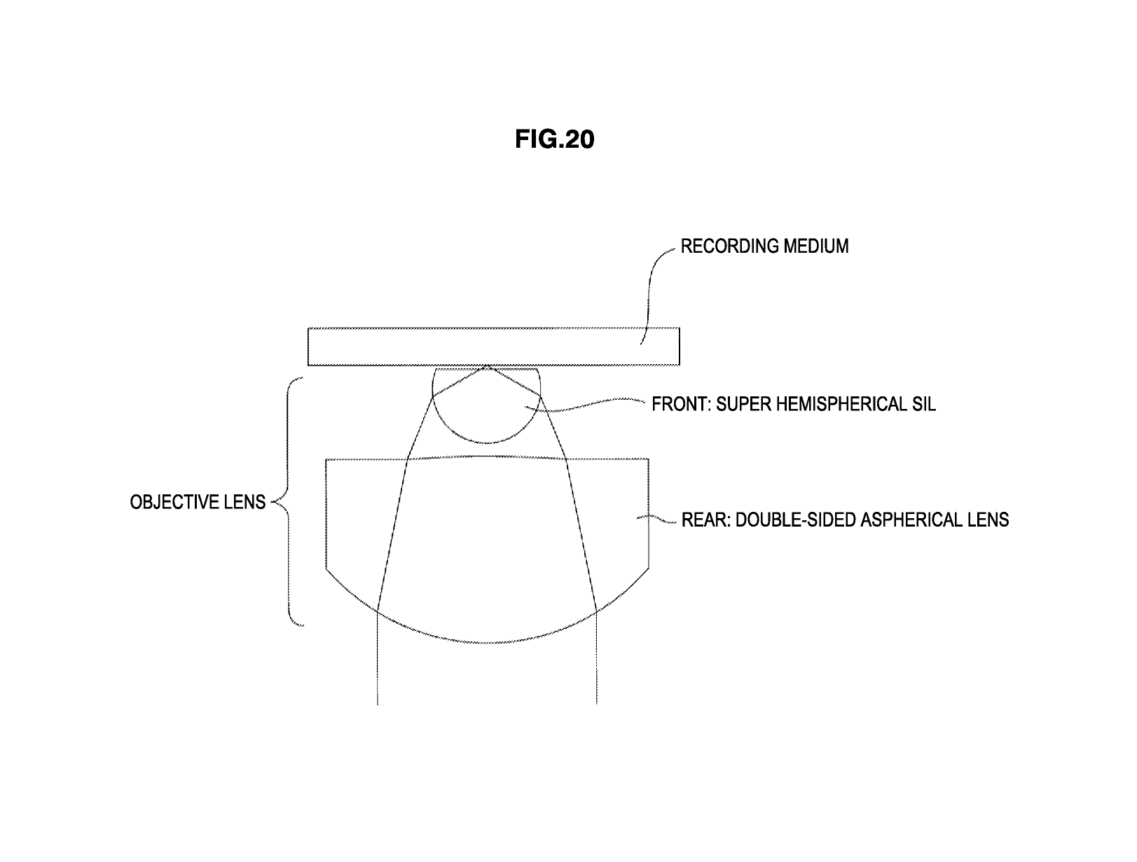

At this time, according to the diameter and the forming pitch described above, in the objective lens including the front lens by the super hemispherical SIL illustrated in FIG. 20, the spot diameter becomes too large, and it is very difficult to appropriately perform recording/reproducing for each of the dots DT. Specifically, it is very difficult to support the high-density pattern medium in which the spot diameter by the objective lens of the related art illustrated in FIG. 20 is about 220 nm, the diameter of each of the dots DT is about 11 nm, and the forming pitch of the dots DT is about 22 nm.

Thus, in the present embodiment, using an objective lens in which a hyper lens is embedded, it is possible to implement the spot diameter capable of supporting the optical disc D of this example.

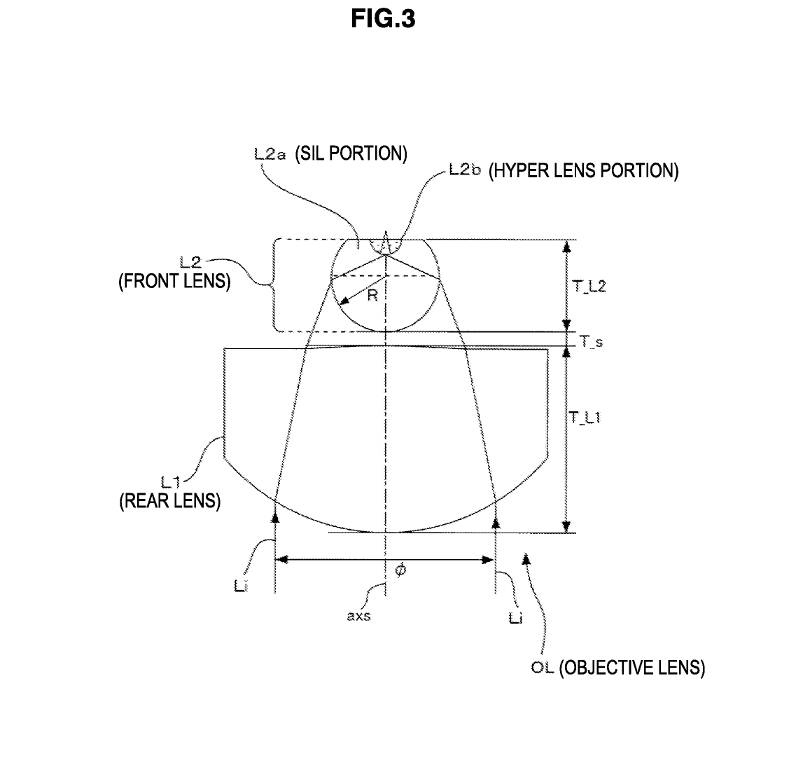

FIG. 3 is a diagram for describing a configuration of an objective lens OL used in the present embodiment.

FIG. 3 illustrates a cross section of the objective lens OL.

In FIG. 3, an incident light L1 to the objective lens OL and an optical axis axs are also illustrated.

As illustrated in FIG. 3, the objective lens OL is a two-group lens including a rear lens L1 and a front lens L2. In this case, a double-sided aspherical lens is used as the rear lens L1. The rear lens L1 causes convergent light based on the incident light L1 to be incident on the front lens L2.

The front lens L2 is a lens in which an SIL portion L2a is integrated with a hyper lens portion L2b.

The SIL (the SIL portion L2a) used in the front lens L2 is an SIL having a super hemispherical shape illustrated in FIG. 3. Specifically, an example in which a super hemispherical SIL in which a surface at an object side is a plane surface is used as the SIL portion L2a is illustrated in this case.

For the sake of confirmation, the “object side” refers to a side on which an object which is a target of light irradiation by an objective lens is arranged. Since this case assumes application of the optical disc D to a recording/reproducing system, the object side refers to a side on which the optical disc D is arranged.

The SIL portion L2a serving as a solid immersion lens is made of a high refractive index material in which a refractive index is at least larger than 1, and generates near-field light (evanescent light) by a numerical aperture of NA>1 based on incident light from the rear lens L1.

In the front lens L2, the hyper lens portion L2b is formed in the SIL portion L2a facing an objective surface as illustrated in FIG. 3. Through this configuration, light by NA>1 generated by the SIL portion L2a is incident on the hyper lens portion L2b.

As illustrated in FIG. 3, the hyper lens portion L2b has a substantially hemispherical shape as an overall shape.

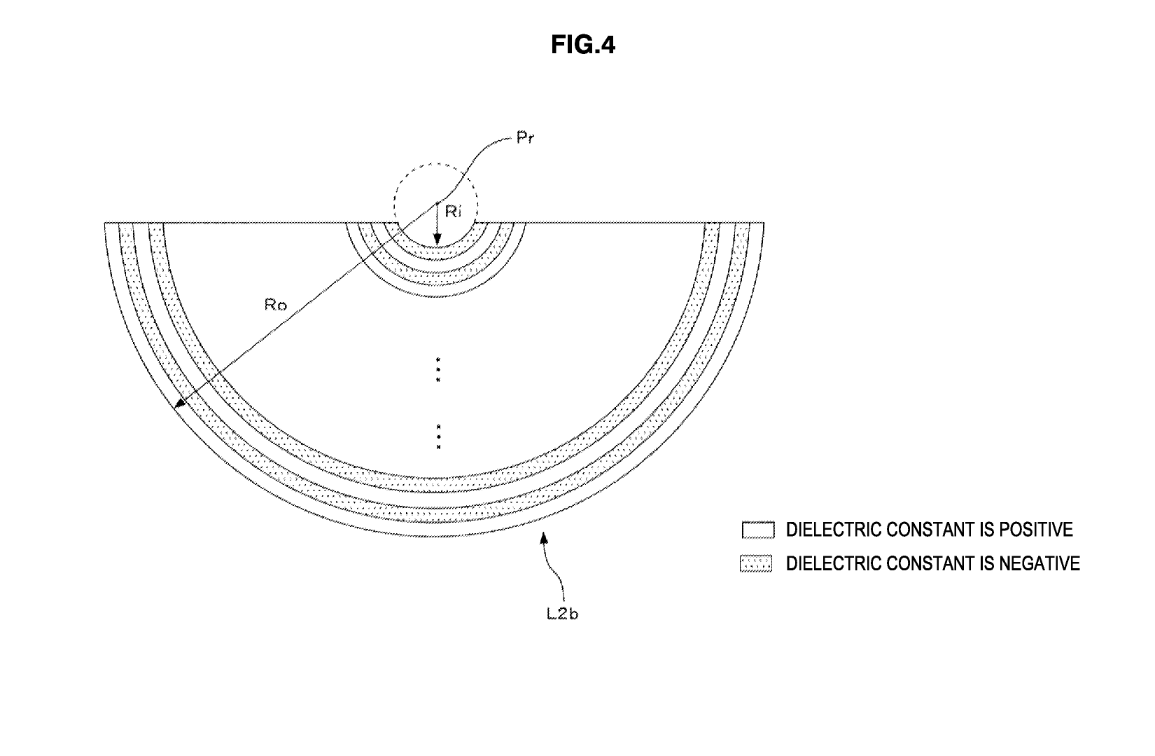

FIG. 4 is an enlarged cross-sectional view of the hyper lens portion L2b.

As illustrated in FIG. 4, the hyper lens portion L2b has the structure in which a plurality of thin films are stacked.

Specifically, the hyper lens portion L2b is formed such that a first thin film whose dielectric constant ∈ is negative (∈<0) and a second thin film whose dielectric constants is positive (∈>0) are alternately stacked.

Here, a material having a negative dielectric constant ∈ is also called a plasmonic material. Examples of the plasmonic material include Ag, Cu, Au, and Al.

Further, examples of a material having a positive dielectric constant ∈ include a silicon-based compound such as SiO₂, SiN, or SiC, a fluoride such as MgF₂ or CaF₂, a nitride such as GaN or MN, a metal oxide, a glass, and a polymer.

Here, the dielectric constant ∈ changes depending on a wavelength λ, of used light. Thus, it is desirable to select materials of the first thin film and the second thin film according to the wavelength λ, so that a desired dielectric constant ∈ can be obtained.

In this example, it is assumed that Ag is selected as a material of the first thin film, and Al₂O₃ is selected as a material of the second thin film under the assumption that the wavelength λ, is about 405 nm.

In FIG. 4, stacking the first thin film and the second thin film is performed, along a spherical surface by a radius Ri having a predetermined reference point Pr, which is set to the outside of the object side of the hyper lens portion L2b (which is the same as the outside of the object side of the front lens L2), as the center, up to a range of a spherical surface by a radius Ro (Ro>Ri) having the reference point Pr as the center. At this time, since stacking the first thin film and the second thin film is performed with reference to the spherical surface, stacking of each thin film is performed in a dome form as illustrated in FIG. 4. As a result, the hyper lens portion L2b has an annual tree-ring shaped (a half annual tree-ring shaped) cross section as illustrated in FIG. 4.

For the sake of confirmation, the hyper lens portion L2b has a substantially semicircular shape as an overall shape as described above. Thus, a surface of the hyper lens portion L2b at the object side has a planar shape excluding a portion having the shape of a spherical surface by the radius Ri. The surface of the hyper lens portion L2b at the object side has the almost planar shape as described above because the surface of the hyper lens portion L2b at the object side should be formed to correspond to the surface shape of the SIL portion L2a, at the object side, with which the hyper lens portion L2b is integrally formed, formed to have the planar shape.

Here, a total of the number of layers on which the first thin film and the second thin film are stacked is preferably in a range of 3 to 100,000. Specifically, in this example, a total of the number of layers on which the first thin film and the second thin film are stacked is about 68.

Preferably, each thin film has a film thickness of 4 nm to 40 nm, and in this example, the first and second thin films have film thicknesses of 10 nm.

As described above, the hyper lens portion L2b has the structure in which the first thin film having a negative dielectric constant and the second thin film having a positive dielectric constant are alternately stacked. Through this structure, the hyper lens portion L2b can propagate light (near-field light) of NA>1 in a direction parallel to a stacking direction of a thin film. In other words, light of NA>1 generated by the SIL portion L2a can be propagated and then exit to the object side.

Further, according to the stacking structure of the hyper lens portion L2b described above, when light incident from the spherical surface side of the radius Ro exits from the spherical surface side of the radius Ri, flux of light (that is, the spot diameter of light) can be reduced by a degree corresponding to a ratio (Ro/Ri) of the radius Ro to the radius Ri.

Through this operation, the hyper lens portion L2b can be further reduce to a small optical spot realized by light of NA>1 generated by the SIL portion L2a and propagate the light to be irradiated to the optical disc D.

As a result, according to the objective lens OL, recoding can be realized with a smaller spot diameter than the objective lens using the SIL of the related art.

Further, the hyper lens portion L2b having the structure illustrated in FIG. 4 can increase flux of return light from the object side by a degree corresponding to the ratio of the radius Ro to the radius Ri. In other words, the hyper lens portion L2b can reversibly reduce or increase flux of light.

The objective lens OL including the hyper lens portion L2b capable of reversibly reducing/increasing flux of light can also perform reading on the dots DT on which recording has been performed using the objective lens OL.

In other words, as a result, it is possible to implement both recording and reproducing using a common optical system, similarly to the optical disc system of the related art such as a CD, a DVD, and a BD. That is, it is unnecessary to employ a complicated configuration in which an optical system used for recording is different from an optical system used for reproducing.

Using the hyper lens portion L2b described above, the spot diameter can be reduced to up to about 30 nm. Specifically, for example, let us assume that the wavelength λ, is 405 nm, Ro/Ri is 6.58, the thickness T_L1 (the length in a direction parallel to the optical axis axs) of the rear lens L1 illustrated in FIG. 3 is 1.7 mm, the thickness T_L2 of the SIL portion L2a is 0.7124 mm, the radius R of the SIL portion L2′a is 0.45 mm, a space T_s between the rear lens L1 and the front lens L2 a (distance from a vertex of the object side surface of the rear lens L1 to a vertex of the super hemispherical surface of the SIL portion L2a) is 0.1556 mm, and the diameter cp of the incident light L1 (parallel light) to the rear lens L1 is 2.1 mm.

In this case, the spot diameter of about 33 nm is realized.

[2-2. Concrete Recording/Reproducing Technique]

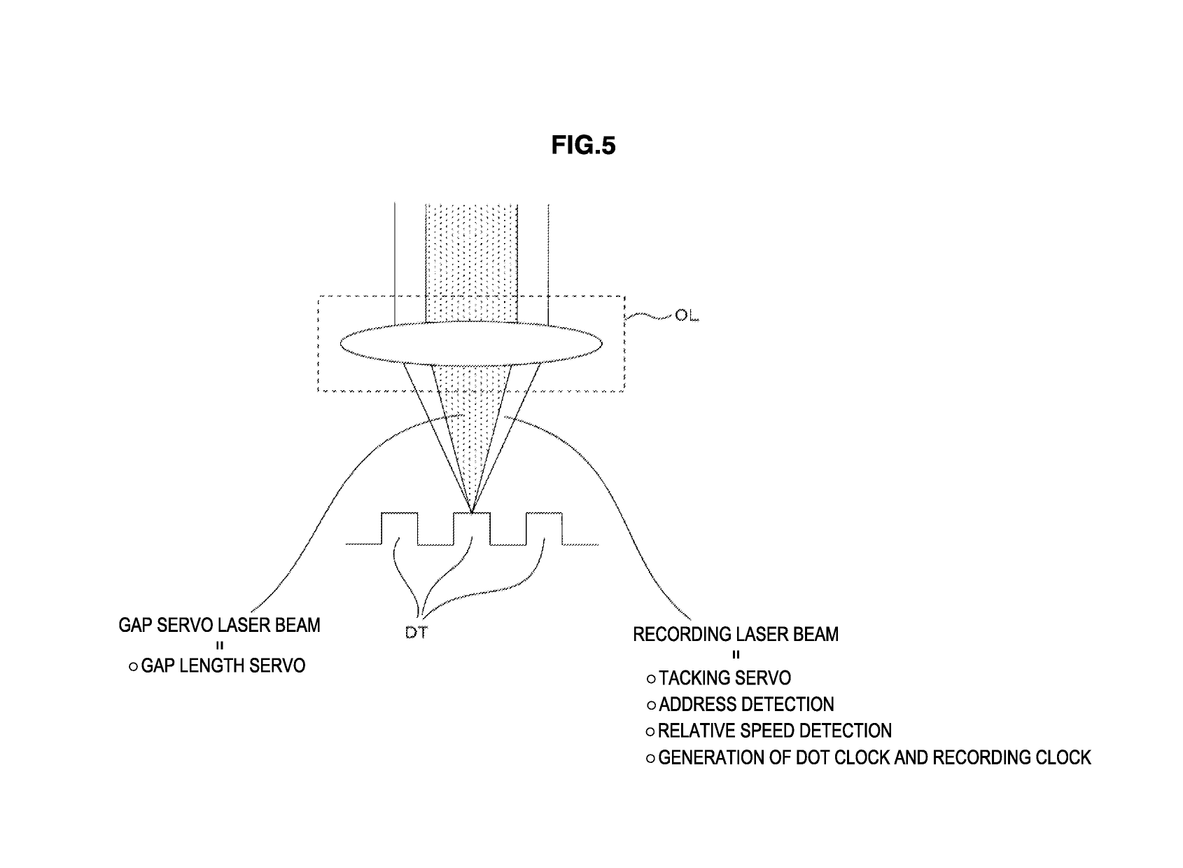

FIG. 5 is a diagram for describing an outline of a recording/reproducing technique for the optical disc D.

First, when recording/reproducing is performed by the near field method as in the present embodiment, it is necessary to perform a so-called gap length servo of maintaining a gap (gap length) as a distance between the objective surface of the objective lens and the recording medium (recording surface) to a predetermined adjacent distance so that light (near-field light) for which NA>1 can be propagated (irradiated) to the recording medium.

Next, a concept of the gap length servo will be described.

It can be evaluated whether or not the gap length is appropriate in the gap length servo, that is, whether or not a near field bonding state has been appropriately obtained, using a quantity of return light from the recording medium as an index. Here, a property by which, when the gap length is inappropriate and the near-field effect is not obtained, irradiation light is fully reflected against the objective surface side end surface of the objective lens, and thus a quantity of return light becomes maximum, whereas when the gap length is appropriate and the near-field effect is obtained, a quantity of return light from the objective surface side end surface is reduced is used.

The gap length servo is naturally considered to be performed using return light of a recording/reproducing laser beam to perform recording/reproducing on the optical disc D (the dots DT).

However, when the return light of the recording/reproducing laser beam is used for the gap length servo, a problem occurs, specifically, at the time of recording. Specifically at the time of recording, a quantity of return light (a quantity of reflected light) increases due to irradiation of the recording/reproducing laser beam according to recording power, and thus only a gap length larger than at the time of reproducing can be held. In other words, there occurs a problem in that it is difficult to maintain a proper gap length necessary for near field recording.

Alternatively, as a countermeasure against this problem, auto gain control (AGC) may be applied to a light receiving signal (gap length error signal) of return light at the time of recording. However, even when the AGC is applied, the gap length servo deviates easily due to spark noise at the time of power transition of a recording section/non-recording section, and thus it is very difficult to secure servo stability.

In order to avoid this problem, in the present embodiment, the gap length servo is performed using reflected light of a laser beam having a different wavelength from the recording/reproducing laser beam. Specifically, a gap servo laser beam having a different wavelength from the recording/reproducing laser beam is separately irradiated, and the gap length servo is performed using a quantity of return light of the gap servo laser beam as an evaluation index (gap length error signal).

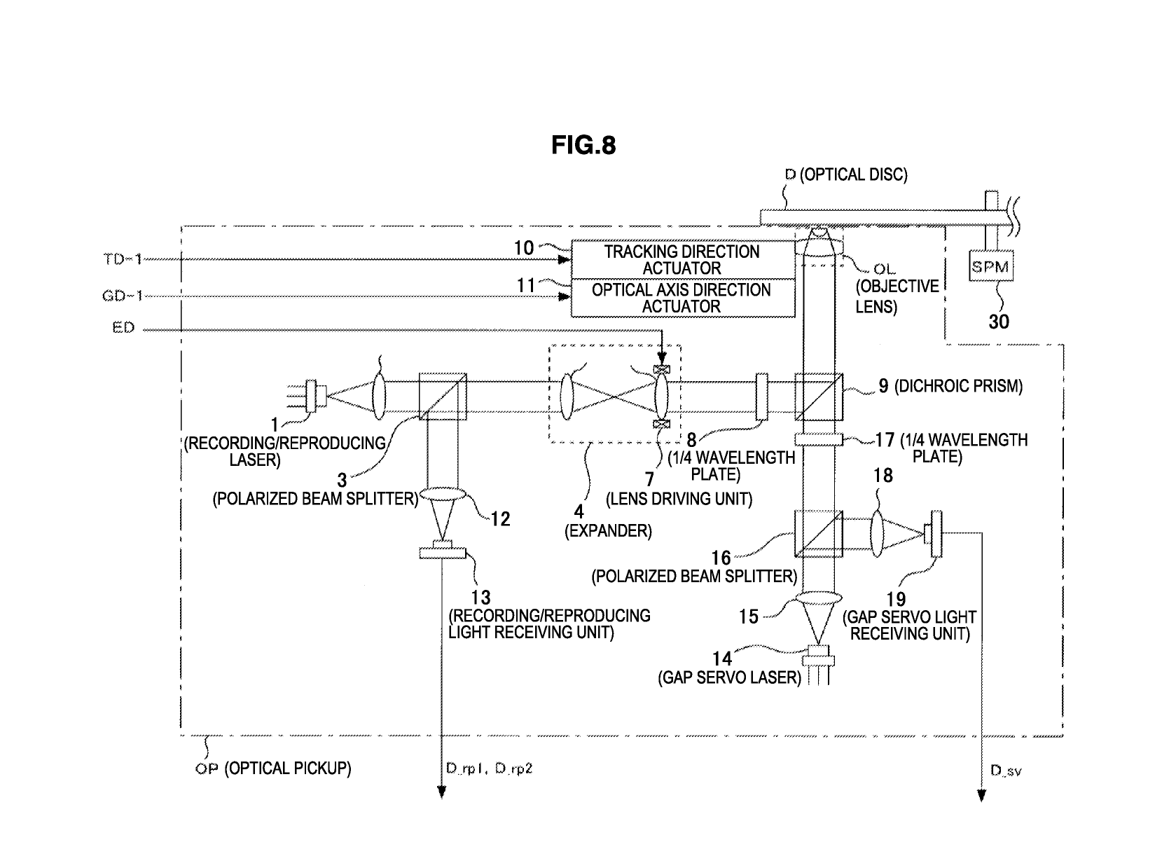

As described above, when the laser beam having a different wavelength from the recording/reproducing laser beam is used, the gap length error signal can be generated using a dichroic prism 9 (FIG. 8), which will be described later, without being affected by the return light of the recording/reproducing laser beam at the time of recording. Accordingly, the appropriate gap length can be maintained even at the time of recording, and the near field recording can be appropriately performed.

Meanwhile, in the present embodiment, the recording/reproducing laser beam is used to perform a tracking servo, address detection, relative speed detection, and generation of a dot clock and a recording clock together with recording/reproducing on the dots DT as illustrated in FIG. 5.

First, when the tracking servo is implemented, the recording/reproducing laser beam and the gap servo laser beam are irradiated to the optical disc D through the common objective lens OL as illustrated in FIG. 5. Through this operation, tracking servo control on the objective lens OL is performed based on reflected light of the recording/reproducing laser beam, and thus the spot position of the gap servo laser beam irradiated through the same objective lens OL can also be similarly controlled.

Here, in the tracking servo, a tracking error signal TE representing a position error of an optical spot formed by irradiation of the recording/reproducing laser beam in the tracking direction with respect to the track Tr is generated based on the reflected light of the recording/reproducing laser beam, and the position of the objective lens OL in the tracking direction is controlled based on the tracking error signal TE.

Through this operation, the optical spot of the recording/reproducing laser beam and the gap servo laser beam can be made to follow the track Tr.

Further, the address detection and the relative speed detection are performed based on a result of detecting the wobbling frequency of the track Tr.

Here, the relative speed refers to the relative speed between the optical disc D and the optical spot of the laser beam irradiated through the objective lens OL.

Specifically, the address detection is performed by demodulating an address information signal recorded by modulation of the wobbling frequency of the track Tr.

The relative speed detection is performed by detecting the wobbling frequency (the central frequency) of the track Tr.

Further, generation of a dot clock and a recording clock are performed as follows.

Here, the dot clock refers to a clock synchronized with the forming period of the dots DT arranged on the optical disc D. In the present embodiment, the dot clock Dclk representing the original forming period of the dots DT as is generated.

Here, when the optical disc D of the present embodiment has the structure illustrated in FIG. 1B, a reflectance difference is given by setting a height difference of about 10 nm between the dots DT and the other portion.

Specifically, in this case, when the optical disc D has the structure illustrated in FIG. 1B, there is a reflectance difference between the dots DT and the other portion in both of the recording state and the non-recording state of the dots DT.

The dot clock Dclk can be generated using a change in the light receiving signal level corresponding to the reflectance difference. Specifically, the dot clock Dclk is generated such that an edge timing of the dot DT is detected using a change in the light receiving signal level corresponding to the reflectance difference, and a synchronization process by a phase locked loop (PLL) is performed based on the phase information.

Meanwhile, in the optical disc D according to the present embodiment, the track Tr is continuously formed on the recording surface as illustrated in FIG. 2. In other words, in the optical disc D according to the present embodiment, a data recording region (a region in which the small record carriers are arranged) in the pattern medium of the related art is continuously formed, and thus a servo pattern region is not inserted.

When the servo pattern region is not provided as described above, generation of a clock (the dot clock Dclk) necessary to properly apply the recording pulse to the small record carriers at the time of recording needs to be performed in the data recording region serving as the region in which the small record carriers are arranged.

However, when optical recording is performed as in the present embodiment, it is very difficult to generate the dot clock Dclk using the reflected light of the recording/reproducing laser beam at the time of recording (since a quantity of reflected light is excessive). Thus, it is not realistic to generate the dot clock Dclk in the region in which the small record carriers are arranged during recording.

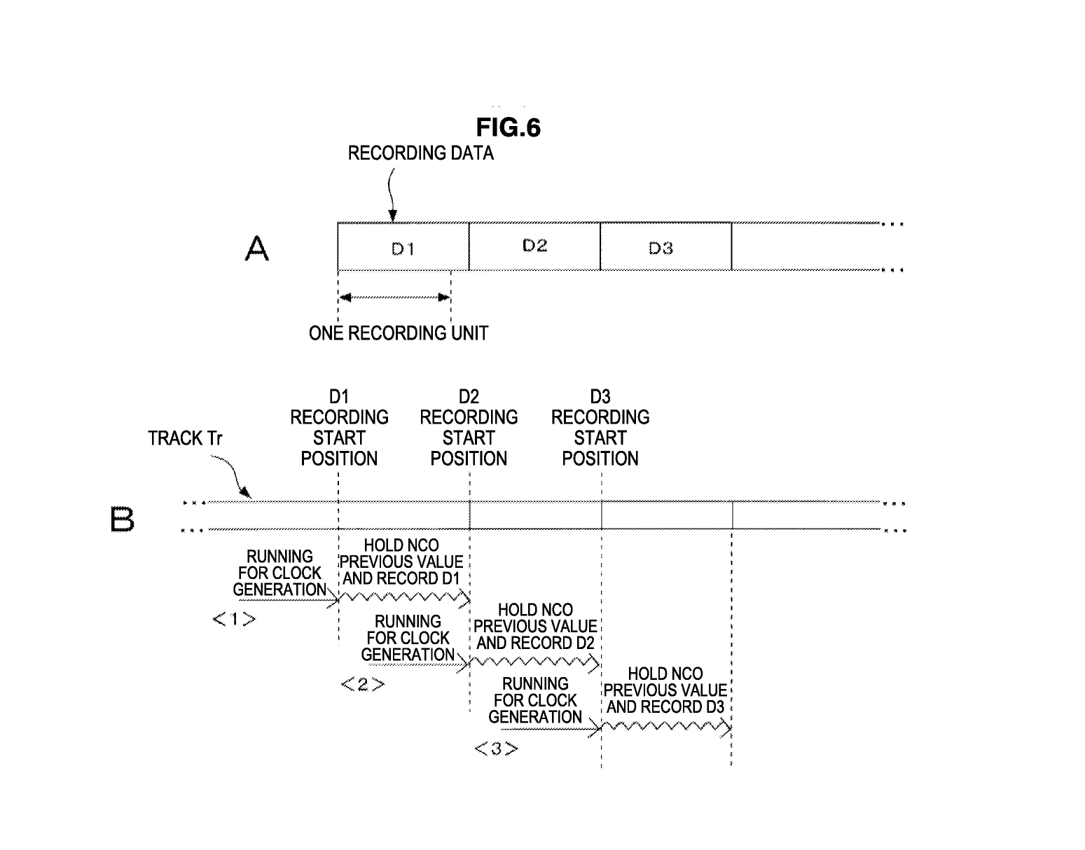

In this regard, in the present embodiment, a recording technique which will be described with reference to FIG. 6 is employed in order to generate an appropriate recording clock (a clock to apply a recording pulse at the forming position of the dots DT at the time of recording).

In FIG. 6, FIG. 6A schematically illustrates data (recording data) to be recorded on the optical disc D, and FIG. 6B schematically illustrates the track Tr.

First, in the recording technique in this case, a predetermined recording unit illustrated in FIG. 6A is decided in advance (one recording unit in FIG. 6A). Referring to FIG. 6A, respective pieces of data obtained by dividing recording data into recording units are represented by data D1, data D2, and data D3.

When respective pieces of data are assumed to be recorded as the data D1, data D2, and data D3 in order from a predetermined position (a predetermined address) on the track Tr, the recording start position of each piece of data D on the track Tr is obtained based on information the recording start position and information of the data length (that is, one recording unit) of each piece of data D.

FIG. 6B illustrates the recording start position of the data D1, the recording start position of the data D2, and the recording start position of the data D3.

Here, as described above, it is very difficult to generate the dot clock Dclk using the reflected light of the recording/reproducing laser beam at the time of recording. In other words, it is very difficult to generate the dot clock Dclk while executing recording on the dots DT through the recording/reproducing laser beam.

In this regard, in the present embodiment, running to generate a recording clock is performed as in <1>, <2>, and <3> in FIG. 6B.

Specifically, for recording of the data D1, running to generate the recording clock is performed in a section before the recording start position of the data D1. In other words, in a corresponding preceding section, a recording/reproducing laser beam is emitted according to reproducing power, and the dot clock Dclk is generated based on the reflected light of the recording/reproducing laser beam. Then, at a timing at which the recording start position of the data D1 arrives, the phase of the dot clock Dclk generated by running in the preceding section is held, and then the data D1 is recorded from the recording start position of the data D1 using the clock whose phase is held as the recording clock.

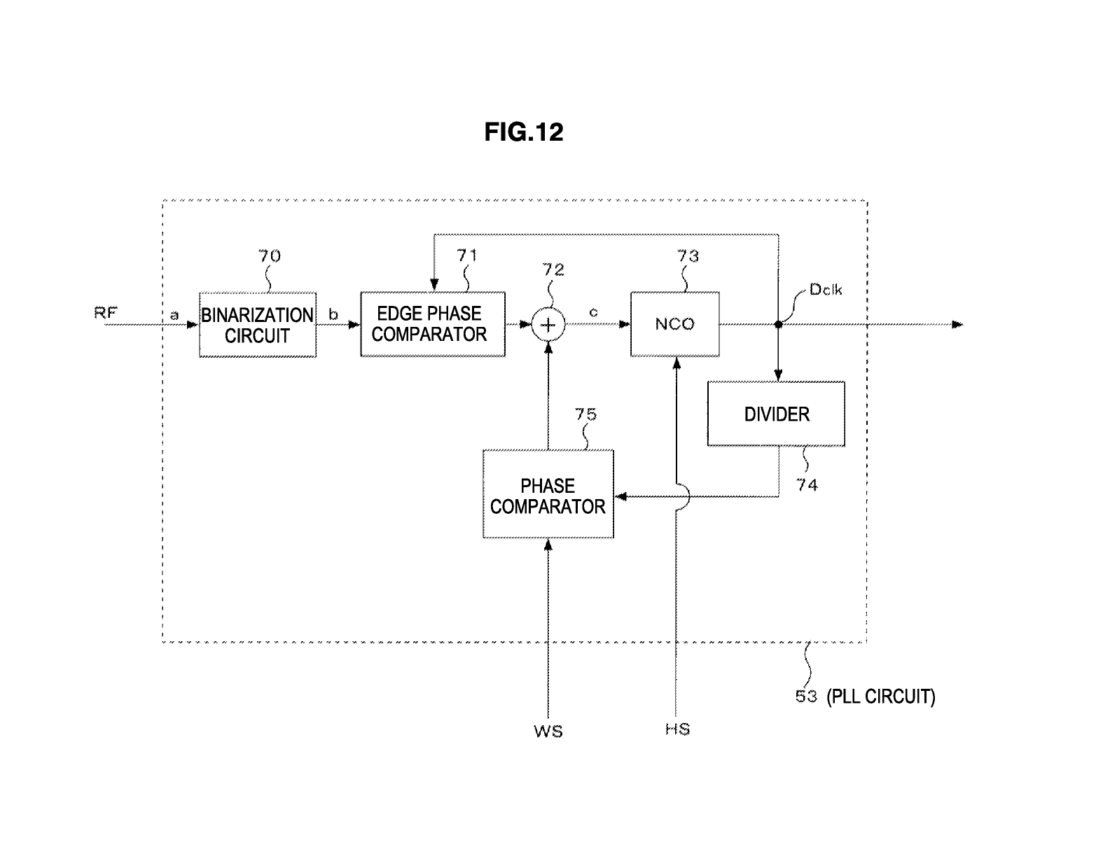

Here, a previous value hold type numerical controlled oscillator (NCO) (an NCO 73 in FIG. 12) is used to hold the phase as will be described later.

Then, for recording of the data D2, the same running as described above is performed in the recording section of the data D1 to generate a recording clock. Specifically, after recording of the data D1 of <1>, first, a beginning part of the preceding section before the recording start position of the data D2 is sought. Thereafter, in the preceding section before the recording start position of the data D2, a recording/reproducing laser beam is emitted according to reproducing power, and the dot clock Dclk is generated based on the reflected light of the recording/reproducing laser beam. Then, at a timing at which the recording start position of the data D2 arrives, the phase of the dot clock Dclk generated by running in the preceding section is held, and then the data D2 is recorded from the recording start position of the data D2 using the clock whose phase is held as the recording clock.

The data D3 and subsequent data are recorded by the same technique as recording of the data D2. In other words, when data D of one recording unit of a recording target is defined as data Dn, first, a beginning part of the preceding section of the data Dn is sought, and then running (generating of the dot clock Dclk) is performed in the preceding section. Then, at a timing at which the recording start position of the data Dn arrives, the phase of the dot clock Dclk generated by running in the preceding section is held, and then the data Dn is recorded from the recording start position of the data Dn using the clock whose phase is held as the recording clock.

As described above, running using the preceding section of the recording target section on the track Tr is performed to generate the dot clock Dclk, and recording using the recording clock obtained by holding the phase of the dot clock Dclk generated by the running is performed in the recording target section. Thus, recording can be properly performed on the dots DT without inserting the servo pattern region as in the pattern medium of the related art.

Here, in the recording technique, when the data length (the section length) of one recording unit is too long, separation of the phase state between the forming period of the dots DT and the recording clock increases. In this case, it is difficult to appropriately apply the recording pulse at the forming position of the dots DT, and thus the recording operation is highly likely to be unstable. The length of one recording unit is appropriately set in terms of stability of the recording operation.

Meanwhile, according to the recording technique, the running to generate the recording clock is performed using a section in which recording has already been completed.

Here, in the recorded section, the dots DT include both those in the recording state and those in the non-recording state together.

In this case, if a reflected light level of the dots DT in the recording state (or the dots DT in the non-recording state) is identical to a reflected light level of a portion in which the dots DT are not formed, even if the running is performed using the recorded section as the preceding section, it is difficult to detect an edge timing of each dot DT, and thus it is difficult to acquire the accurate dot clock Dclk (and thus also the recording clock).

In light of this point, in the present embodiment, the optical disc D is configured such that there is a reflectance difference between the forming portion and the non-forming portion of the dots DT in both of the recording/non-recording states of the dots DT. As a result, regardless of whether the dot DT is in the recording state or the non-recording state, the edge timing of the dot DT can be detected, and thus the accurate recording clock can be generated even when the recorded section is used for the running. In other words, from this point of view, it is unnecessary to perform insertion of the servo pattern region, which needs to be performed in the sector servo method of the related art.

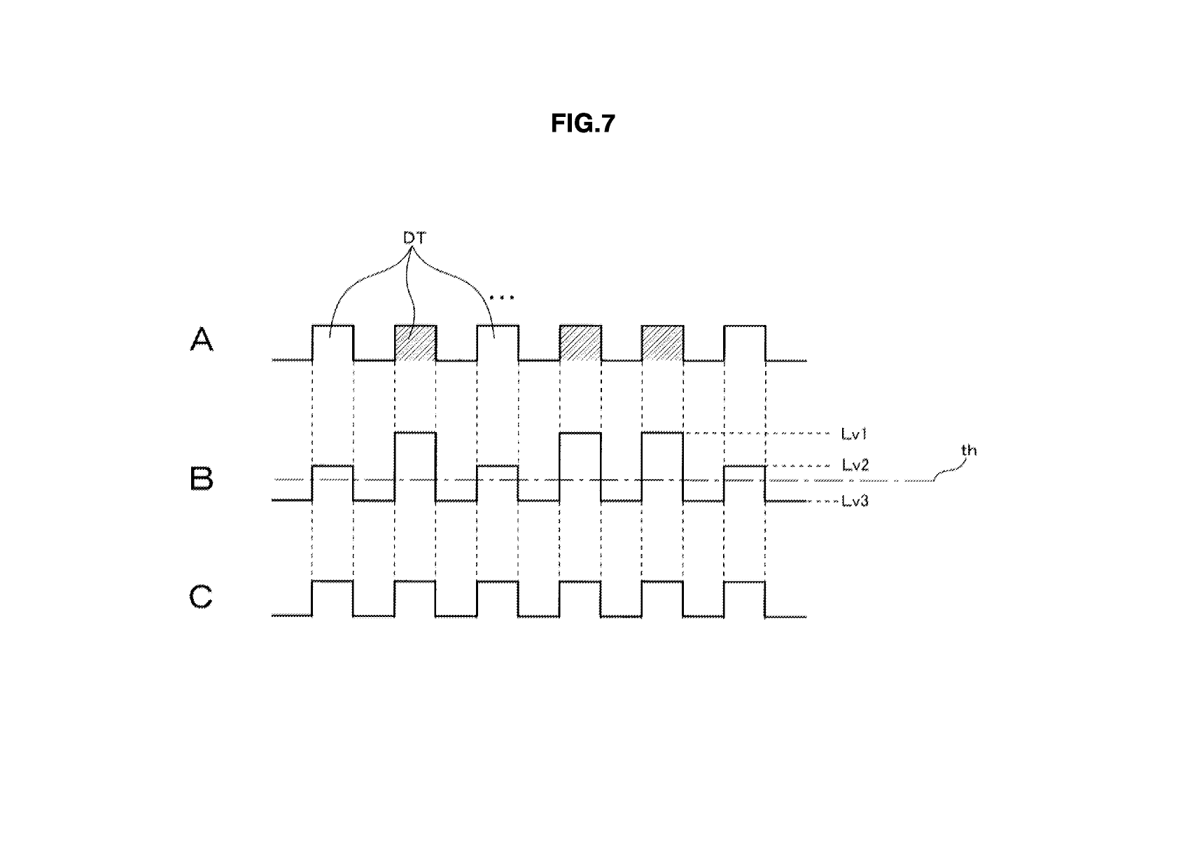

FIG. 7 is a diagram for describing a technique of generating the dot clock Dclk in a running section.

Specifically, FIG. 7A illustrates an example of the dots DT arranged in the running section, FIG. 7B schematically illustrates a waveform of a read signal obtained in the running section, and FIG. 7C illustrates a waveform of the dot clock Dclk obtained in the running section.

In FIG. 7A, a white dot DT represents a dot DT in the non-recording state, and a hatched dot DT represents a dot DT in the recording state.

As a first assumption, as can be understood from a comparison between FIG. 7A and FIG. 7B, there is a difference in an amplitude level between the read signal obtained by the dot DT in the recording state and the read signal obtained by the dot DT in the non-recording state. Specifically, in this example, a relation of “the read signal level of the dot DT in the recording state> the read signal level of the dot DT in the non-recording state” is obtained.

Here, the read signal level of the dot DT in the recording state is represented by a level Lv1, and the read signal level of the dot DT in the non-recording state is represented by a level Lv2. Further, the read signal level of the forming portion of the dots DT is represented by a level Lv3.

In this case, binarization is performed on a read signal (FIG. 7B) in which a threshold value th is set to a slice level as illustrated in FIG. 7C, and then generation of the dot clock Dclk is performed based on the binary signal.

Specifically, a value satisfying a condition of “Lv3<th<Lv 1, Lv2” is set as the threshold value th. Thus, regardless of whether the dots DT are in the recording state or the non-recording state, a signal appropriately representing the edge timing of each dot DT can be obtained as the binary signal.

Meanwhile, as can be understood from the above description, in the optical disc D according to the present embodiment, a reflectance difference is given between the dots DT and the remaining portion.

Thus, even at the time of recording in which the dots DT are in the non-recording state, the tracking error signal TE can be generated in the region in which the dots DT are arranged.

Here, in the pattern medium which has been proposed in an HDD of the related art, it is difficult to obtain a signal amplitude difference between the small record carrier portion and the remaining portion in the data recording region in which the small record carriers are arranged, particularly, at the time of recording in which the small record carriers are in the non-recording state, and thus it is difficult to perform generation of the tracking error signal (the tracking servo) using the small record carrier in the data recording region at the time of recording. For this reason, the servo pattern region is inserted between the data recording regions, and a sector servo (a sample servo) using the servo pattern region is performed.

On the other hand, according to the optical disc D of the present embodiment having the reflectance difference between the dots DT and the remaining portion, even when the dots DT serving as the small record carriers are in the non-recording state (that is, even at the time of recording), the tracking error signal TE can be generated in the region in which the dots DT are arranged. In other words, the tracking error signal TE can be generated without inserting the servo pattern region other than in the data recording region.

Thus, continuous tracking servo control, rather than intermittent servo control such as the sector servo method, can be implemented.

As described above, continuous servo control can be performed rather than intermittent servo control, the servo tracking range is larger than in the related art employing the sector servo method, and the servo gain can be easily increased. As a result, followability of eccentricity is improved, and stable tracking servo can be implemented without specially needing the mechanical adjustment.

Further, in the present embodiment, the track Tr on which the dots DT are arranged remains wobbled. Thus, it is possible to continuously detect address information and information of the relative speed recorded by wobbling. In other words, when the sector servo method of the related art is employed, the signal amplitude difference is not obtained between the forming portion and the non-forming portion of the small record carrier in the data recording region, and thus detection of the address information and the like is intermittently performed using the servo pattern region. However, according to the present embodiment, the address information and the relative speed information can be continuously detected in the region in which the small record carriers are arranged.

Further, according to the present embodiment in which the optical disc D is configured such that there is a reflectance difference between the forming portion and the non-forming portion of the dots DT in both of the recording state and the non-recording state of the dots DT, the recording clock can be generated using the recorded section on the track Tr as described above as the recording technique. In other words, from this point of view, insertion of the servo pattern region, which needs to be performed in the related art, is unnecessary.

As described above, according to the present embodiment, insertion of the servo pattern region, which needs to be performed in the pattern medium of the related art, is unnecessary, and thus the recording capacity can be increased to be larger than that of the related art.

Further, according to the present embodiment, continuous tracking servo can be performed, and stabler tracking servo than in the related art employing the sector servo method can be implemented.

Furthermore, according to the present embodiment, even when the servo pattern region is not provided, detection of the address information or the relative speed information recorded by wobbling of the track can be continuously performed in the region in which the small record carriers are arranged.

As can be understood from the above description, according to the present embodiment, it is possible to provide a preferred medium structure and recording technique when recording is performed on a pattern medium serving as an optical recording medium.

<3. Recording/Reproducing Apparatus>

[3-1. Configuration of Optical Pickup]

Next, a configuration of an apparatus for implementing a recording/reproducing technique of the present embodiment described above will be described.

FIG. 8 is a diagram mainly illustrating an internal configuration of an optical pickup (an optical pickup OP) of a recording/reproducing apparatus as an embodiment of a recording apparatus according to the present application.

Referring to FIG. 8, the optical disc D is first rotationally driven by a spindle motor (SPM) 30. Light irradiation to record information or reproduce recording information by the optical pickup OP is performed on the optical disc D rotationally driven by the spindle motor 30.

An optical system for the recording/reproducing laser beam and an optical system for the gap servo laser beam are disposed in the optical pickup OP.

Here, as described above, laser beams having different wavelength bands are used as the recording/reproducing laser beam and the gap servo laser beam. In this example, for example, the wavelength of the recording/reproducing laser beam is set to about 405 nm, and the wavelength of the gap servo laser beam is set to about 650 nm.

First, in the optical system for the recording/reproducing laser beam, a recording/reproducing laser beam emitted from the recording/reproducing laser 1 is converted into parallel light through a collimation lens 2, and is then incident on a polarized beam splitter 3. The polarized beam splitter 3 is configured to allow the recording/reproducing laser beam incident from the recording/reproducing laser 1 side to pass through as described above.

The recording/reproducing laser beam that has passed through the polarized beam splitter 3 is incident on an expander 4 including a fixed lens 5, a movable lens 6, and a lens driving unit 7. In the expander 4, the fixed lens 5 is arranged at the side close to the recording/reproducing laser 1 serving as a light source, and the movable lens 6 is arranged at the side far from the recording/reproducing laser 1. The lens driving unit 7 drives the movable lens 6 in a direction parallel to an optical axis of the recording/reproducing laser beam.

In the expander 4, driving of the lens driving unit 7 is controlled (that is, the movable lens 6 is driven in a direction parallel to the laser beam axis) by a drive signal ED illustrated in FIG. 8, and so correction of the focusing position on the recording/reproducing laser beam (correction of focus misalignment caused by chromatic aberration between the gap servo laser beam and the recording/reproducing laser beam) can be performed.

The recording/reproducing laser beam that has passed through the fixed lens 5 and the movable lens 6 in the expander 4 is incident on the dichroic prism 9 through a ¼ wavelength plate 8.

The dichroic prism 9 is configured such that a selective reflecting surface reflects light having the wavelength band as the recording/reproducing laser beam, and transmits light having other wavelength bands. Thus, the recording/reproducing laser beam incident in the above-described way is reflected by the dichroic prism 9.

The recording/reproducing laser beam reflected by the dichroic prism 9 is incident on the optical disc D through the objective lens OL as illustrated in FIG. 8.

Here, for the objective lens OL, a tracking direction actuator 10 that displaces the objective lens OL in the tracking direction (a radial direction of the optical disc D) and an optical axis direction actuator 11 that displaces the objective lens OL in an optical axis direction (a focus direction) are disposed.

In this example, a piezo actuator is used as both the tracking direction actuator 10 and the optical axis direction actuator 11.

In this case, the objective lens OL is held by the tracking direction actuator 10, and the tracking direction actuator 10 that holds the objective lens OL is held by the optical axis direction actuator 11. Thus, by driving the tracking direction actuator 10 and the optical axis direction actuator 11, the objective lens OL can be displaced in the tracking direction and the optical axis direction.

Even when the optical axis direction actuator 11 holds the objective lens OL and the tracking direction actuator 10 holds the optical axis direction actuator 11, the same effect can be obtained.

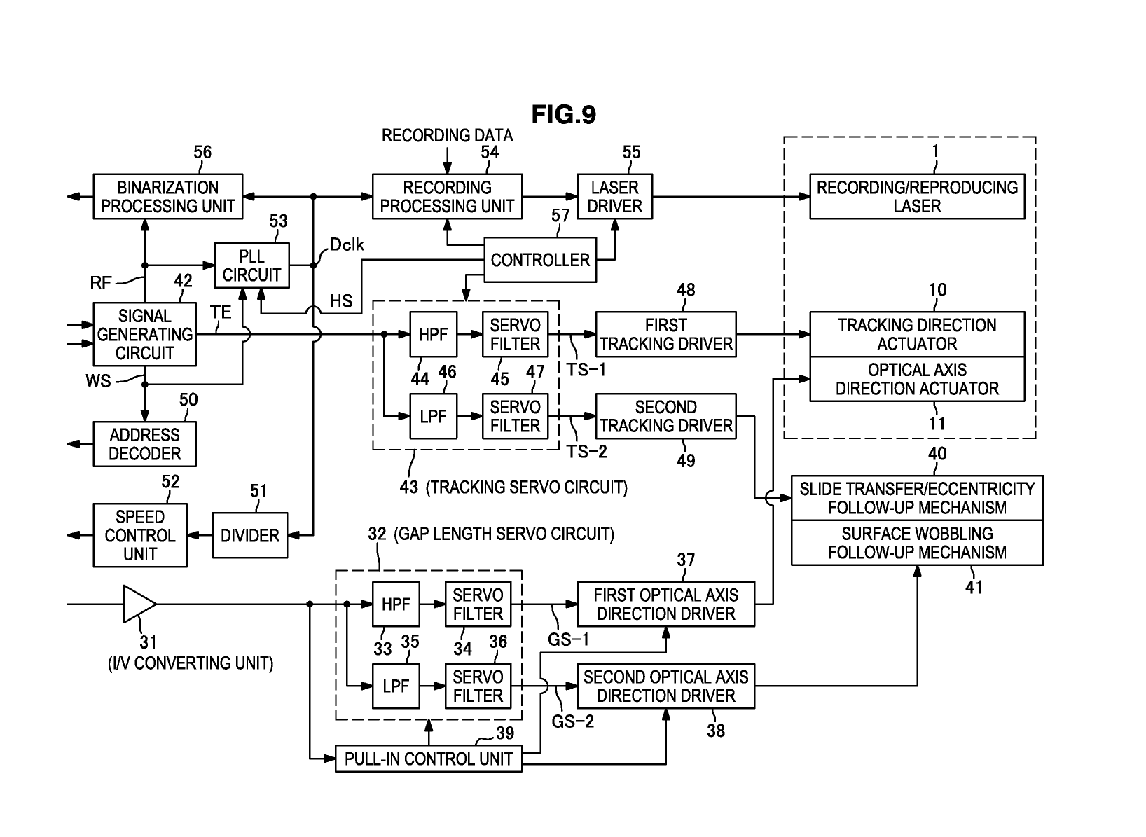

The tracking direction actuator 10 is driven based on a first tracking drive signal TD-1 from a first tracking driver 48 illustrated in FIG. 9.

Further, the optical axis direction actuator 11 is driven based on a first optical axis direction drive signal GD-1 from a first optical axis direction driver 37 illustrated in FIG. 9.

Here, at the time of reproducing, when the recording/reproducing laser beam is irradiated to the optical disc D as described above, reflected light from the recording layer Lr is obtained. The reflected light of the recording/reproducing laser beam obtained as described above is guided to the dichroic prism 9 through the objective lens OL, and then reflected by the dichroic prism 9.

The reflected light of the recording/reproducing laser beam reflected by the dichroic prism 9 passes through the ¼ wavelength plate 8 and the expander 4 (the movable lens 6 and then the fixed lens 5) in order, and then incident to the polarized beam splitter 3.

Here, the reflected light (return path light) from the recording/reproducing laser beam incident on the polarized beam splitter 3 has a polarizing direction that differs by 90 degrees from the recording/reproducing laser beam (outward light) incident from the recording/reproducing laser 1 side on the polarized beam splitter 3 due to an operation by the ¼-wavelength plate 8 and an operation on the recording surface of the optical disc D at the time of reflection. As a result, the reflected light of the recording/reproducing laser beam incident as described above is reflected off of the polarized beam splitter 3.

The reflected light of the recording/reproducing laser beam reflected off of the polarized beam splitter 3 is focused on a light receiving surface of a recording/reproducing light receiving unit 13 through a condensing lens 12.

The recording/reproducing light receiving unit 13 includes two light receiving elements in this example, and is arranged such that the light receiving elements can generate the tracking error signal TE (a push-pull signal) and a radio frequency (RF) signal (a read signal).

Hereinafter, the light receiving signal generated by one of the light receiving elements included in the recording/reproducing light receiving unit 13 is referred to as a light receiving signal D_rp1, and the light receiving signal generated by the other light receiving element is referred to as a light receiving signal D_rp2.

In the optical pickup OP illustrated in FIG. 8, the optical system for the gap servo laser beam is provided with a gap servo laser 14, a collimation lens 15, a polarized beam splitter 16, a ¼ wavelength plate 17, a condensing lens 18, and a gap servo light receiving unit 19.

The gap servo laser beam emitted from the gap servo laser 14 is converted into parallel light through the collimation lens 15, and then incident on the polarized beam splitter 16. The polarized beam splitter 16 is configured to transmit the gap servo laser beam (outward light) incident from the gap servo laser 14 side.

The gap servo laser beam that has passed through the polarized beam splitter 16 is incident on the dichroic prism 9 through the ¼ wavelength plate 17.

As described above, the dichroic prism 9 is configured to reflect light having the same wavelength band as the recording/reproducing laser beam and transmit light having other wavelength bands, and thus the gap servo laser beam passes through the dichroic prism 9 and is then incident on the objective lens OL.

Here, as will be described later, in a state in which the gap length is very large (a state in which the near field bonding does not occur, and light generated by the objective lens OL is not propagated to the optical disc D), the gap servo laser beam is fully reflected by the end surface of the objective lens OL (the end surface of the hyper lens unit L2b), and a quantity of return light becomes a maximum. However, in a state in which the gap length is appropriate (a near field bonding state), a quantity of light reflected by the end surface of the objective lens OL decreases accordingly, and a quantity of return light also decreases.

The gap length servo is performed using a change in a quantity of reflected light of the gap servo laser beam from the end surface of the objective lens OL relative to the gap length.

The reflected light (return path light) of the gap servo laser beam from the end surface of the objective lens OL passes through the dichroic prism 9, and is then incident on the polarized beam splitter 16 through the ¼ wavelength plate 17.

As described above, the reflected light of the gap servo laser beam serving as the return path light incident to the polarized beam splitter 16 having a polarizing direction that differs by 90 degrees from the outward light due to an operation by the ¼-wavelength plate 17 and an operation on the objective lens OL at the time of reflection. Thus, the reflected light of the gap servo laser beam serving as the return path light is reflected by the polarized beam splitter 16.

The reflected light of the gap servo laser beam reflected by the polarized beam splitter 16 is focused on a light receiving surface of a gap servo light receiving unit 19 through the condensing lens 18.

The light receiving signal obtained by the gap servo light receiving unit 19 is referred to as a light receiving signal D_sv as illustrated in FIG. 8.

[3-2. Internal Configuration of Whole Recording/Reproducing Apparatus]

FIG. 9 illustrates an overall internal configuration of a recording/reproducing apparatus according to an embodiment.

Among the components of the internal configuration of the optical pickup OP illustrated in FIG. 8, the recording/reproducing laser 1, the tracking direction actuator 10, and the optical axis direction actuator 11 are selectively illustrated in FIG. 9.

The spindle motor 30 is not illustrated in FIG. 9.

First, as a configuration for implementing the gap length servo, a recording/reproducing apparatus includes an I/V converting unit 31, a gap length servo circuit 32, the first optical axis direction driver 37, a second optical axis direction driver 38, a pull-in control unit 39, and a surface wobbling follow-up mechanism 41.

The surface wobbling follow-up mechanism 41 holds a slide transfer/eccentricity follow-up mechanism 40, which holds the optical pickup OP, to be displaced in the optical axis direction (the gap length control direction).

In this example, the surface wobbling follow-up mechanism 41 is equipped with a linear motor and has relatively rapid responsiveness. The surface wobbling follow-up mechanism 41 drives the slide transfer/eccentricity follow-up mechanism 40 in the optical axis direction by power of the linear motor, and so the optical pickup OP is displaced in the optical axis direction.

Even when a positional relation between the surface wobbling follow-up mechanism 41 and the slide transfer/eccentricity follow-up mechanism 40 is changed, the same effect is obtained, similarly to the relation between the tracking direction actuator 10 and the optical axis direction actuator 11.

The light receiving signal D_sv which has been subjected to I/V conversion by the I/V converting unit 31 functions as an error signal in the gap length servo.

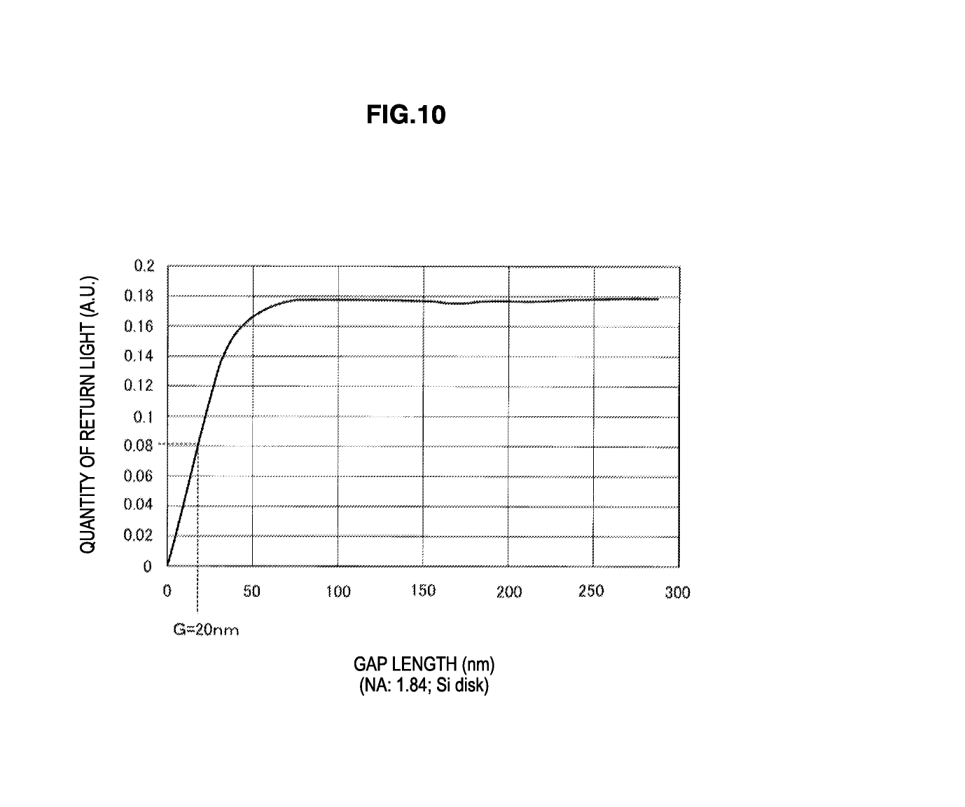

Here, FIG. 10 is a diagram to describe a relation between the gap length and a quantity of return light from the objective lens OL (a quantity of return light from an end surface of the hyper lens portion L2b at the object side).

FIG. 10 illustrates a relation between the gap length and a quantity of return light when a silicon (Si) disc is used as an example. However, even when the recording film Rc made of a phase change material or the like is used as in the present example, almost the same relation as in FIG. 10 is obtained.

Further, in order to obtain the result illustrated in FIG. 10, the effective numerical aperture NA of the objective lens OL was set to 1.84.

As illustrated in FIG. 10, a quantity of return light from the objective lens OL becomes maximum in an area in which the gap length is very large and near field bonding does not occur. As described above, this is because when near field bonding does not occur, irradiation light is fully reflected against an end surface of the objective lens OL (an end surface of the hyper lens portion L2b).

On the other hand, in an area in which the gap length is equal to or less than 50 nm, which is about a fourth (¼) the wavelength, as the gap length decreases, the quantity of return light gradually decreases due to an operation of the near field bonding.

Here, when a priority is given to an operation by near field bonding, the shorter the gap length is, the better. However, when the gap length is reduced, a collision or friction between the objective lens OL and the optical disc D becomes problematic. For this reason, the gap length is set to maintain a gap with the optical disc D to some extent within a range in which near field bonding occurs.

From this point of view, in the present example, the gap length G (gap G) is set to about 20 nm.

In FIG. 10, for example, a target value of a quantity of return light when the gap G is set to 20 nm is about 0.08.

In order to perform the gap length servo, a target value of a quantity of return light is calculated based on a value of the gap G in advance. The gap length servo is performed when a detected quantity of return light becomes constant at a target value which is previously obtained as described above.

The description will now return to FIG. 9.

The light receiving signal D_sv via the IN converting unit 31 is supplied to a dot clock generating circuit 15 which will be described later, and supplied to the gap length servo circuit 32 and the pull-in control unit 39 as illustrated in FIG. 9.

The gap length servo circuit 32 includes a first gap length servo signal generating system configured with a high pass filter (HPF) 33 and a servo filter 34 and a second gap length servo signal generating system configured with a low pass filter (LPF) 35 and a servo filter 36.

The first gap length servo signal generating system corresponds to the optical axis direction actuator 11, and the second gap length servo signal generating system corresponds to the surface wobbling follow-up mechanism 41.

The HPF 33 receives the light receiving signal D_sv that has passed through the I/V converting unit 31, extracts a component equal to or more than a predetermined cutoff frequency from the light receiving signal D_sv, and outputs the extracted component to the servo filter 34.

The servo filter 34 calculates a servo calculation based on the output signal of the HPF 33, and generates a first gap length servo signal GS-1.

Further, the LPF 35 receives the light receiving signal D_sv that has passed through the I/V converting unit 31, extracts a component equal to or less than a predetermined cutoff frequency from the light receiving signal D_sv, and outputs the extracted component to the servo filter 36.

The servo filter 36 calculates a servo calculation based on the output signal of the LPF 35, and generates a second gap length servo signal GS-2.

Here, a target value (that is, an amplitude value of the light receiving signal D_sv at the gap G) on the quantity of return light previously obtained based on the gap G remains set to the gap length servo circuit 32, and the servo filters 34 and 36 generate the first and second gap length servo signals GS-1 and GS-2 to cause the amplitude value of the light receiving signal D_sv to become the corresponding target value.

The first optical axis direction driver 37 drives the optical axis direction actuator 11 by a first optical axis direction drive signal GD-1 generated based on the first gap length servo signal GS-1.

Further, the second optical axis direction driver 38 drives the surface wobbling follow-up mechanism 41 by a second optical axis direction drive signal GD-2 generated based on the second gap length servo signal GS-2.

Here, in the above-described gap length servo circuit 32, the cutoff frequency of the LPF 35 is set to a frequency equal to or more than a surface wobbling period of a disc. This allows the surface wobbling follow-up mechanism 41 to displace the optical pickup OP to follow disc surface wobbling.

As described above, the whole optical pickup OP is driven to follow the surface wobbling, and it is possible to prevent the objective lens OL from colliding with the optical disc D.

The pull-in control unit 39 is disposed to perform pull-in control of the gap length servo.

A target value (that is, an amplitude value of the light receiving signal D_sv at the gap G) on the quantity of return light previously obtained based on the gap G remains set to the pull-in control unit 39. The pull-in control unit 39 performs the pull-in control of the gap length servo based on the set target value as follows.

First, when the gap length servo is in an off state, a difference between the amplitude value of the light receiving signal D_sv input through the IN converting unit 31 and the target value is calculated. Then, it is determined whether or not the difference value is in a pull-in range which is previously set. When the difference value is not in the pull-in range, a pull-in waveform (a signal to change the amplitude value of the light receiving signal D_sv in a direction to reduce the difference) corresponding to the difference is generated, and the pull-in waveform is applied to the first optical axis direction driver 37 and the second optical axis direction driver 38. This allows control to be performed such that the amplitude value of the light receiving signal D_sv falls within the pull-in range.

Then, when the difference value is in the pull-in range, an instruction to turn on a servo loop (both of the first and second gap length servo signal generating systems) is given to the gap length servo circuit 32. This completes the pull-in control.

Further, the recording/reproducing apparatus of the present embodiment has a configuration for performing tracking servo, address detection, relative speed control, and recording/reproducing based on the light receiving signals D_rp1 and D_rp2 obtained by the recording/reproducing light receiving unit 13.

Specifically, this configuration includes a signal generating circuit 42, a tracking servo circuit 43, the first tracking driver 48, a second tracking driver 49, the slide transfer/eccentricity follow-up mechanism 40, an address decoder 50, a divider 51, a speed control unit 52, a PLL circuit 53, a recording processing unit 54, a laser driver 55, and a binarization processing unit 56.

First, the signal generating circuit 42 generates the tracking error signal TE, a wobbling signal WS (a signal related to wobbling of the track Tr), and the RF signal (corresponding to the read signal of FIG. 7B) representing a distinction among the recording portion, the non-recording portion, and the non-forming portion of the dots DT by an amplitude difference based on the light receiving signals D_rp1 and D_rp2.

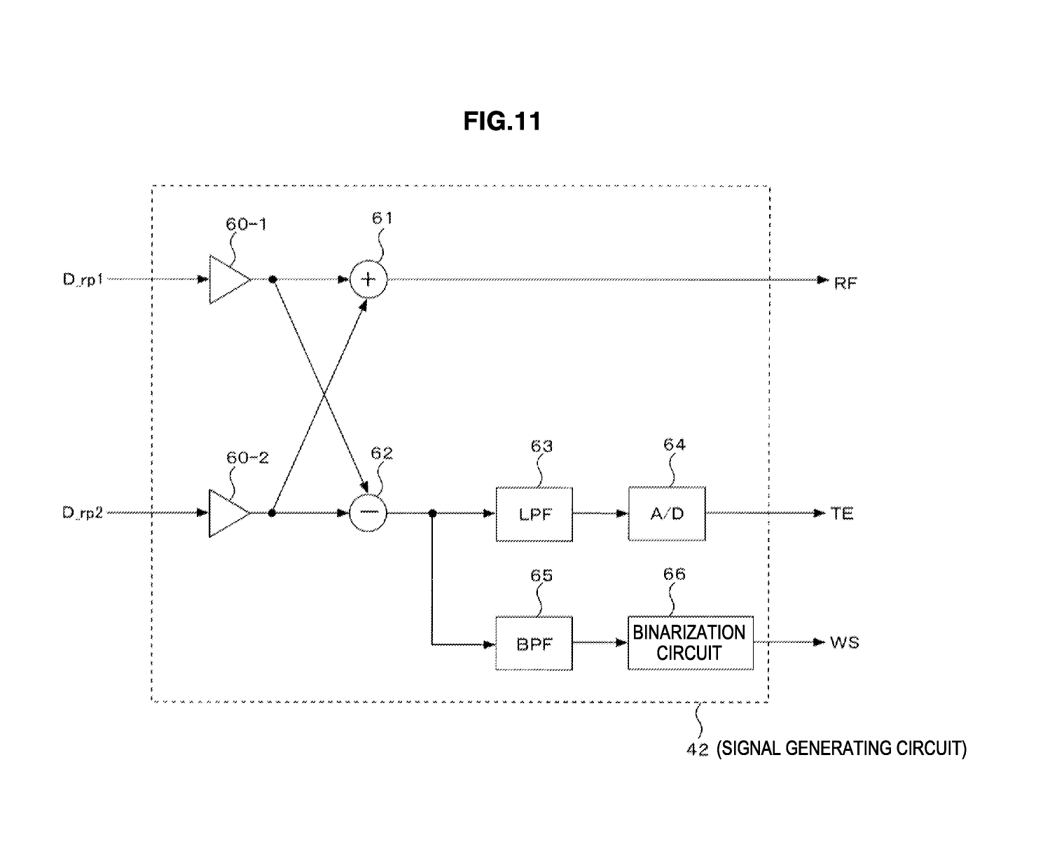

FIG. 11 is a diagram for describing an internal configuration of the signal generating circuit 42.

As illustrated in FIG. 11, the signal generating circuit 42 includes an IV converting unit 60-1, an IV converting unit 60-2, an adding unit 61, a subtracting unit 62, a low pass filter 63, an A/D converter 64, a band pass filter 65, and a binarization circuit 66.

The light receiving signal D_rp1 is subjected to IV conversion by the IV converting unit 60-1, and then supplied to the adding unit 61 and the subtracting unit 62. The light receiving signal D_rp2 is subjected to IV conversion by the IV converting unit 60-2, and then similarly supplied to the adding unit 61 and the subtracting unit 62.

The adding unit 61 adds the light receiving signal D_rp1 from the IV converting unit 60-1 to the light receiving signal D_rp2 from the IV converting unit 60-2. As a result, the RF signal is obtained.

The subtracting unit 62 calculates a difference between the light receiving signal D_rp1 from the IV converting unit 60-1 and the light receiving signal D_rp2 from the IV converting unit 60-2. In other words, through this operation, a so-called push-pull signal is generated.

The differential signal obtained by the subtracting unit 62 is supplied to the low pass filter 63 and the band pass filter 65.

As illustrated in FIG. 11, the differential signal having passed through the low pass filter 63 is subjected to A/D conversion by the A/D converter 64, so that the tracking error signal TE is generated.

Meanwhile, the band pass filter 65 extracts a component of a predetermined frequency band from the differential signal supplied to the band pass filter 65. Then, the extracted component is binarized by the binarization circuit 66, so that the wobbling signal WS is output.

The description will now return to FIG. 9.

The tracking error signal TE generated by the signal generating circuit 42 is supplied to the tracking servo circuit 43. The wobbling signal WS is supplied to the address decoder 50 and the PLL circuit 53.

The RF signal is supplied to the PLL circuit 53 and the binarization processing unit 56.

Here, in the recording/reproducing apparatus, the tracking servo circuit 43, the first tracking driver 48, the second tracking driver 49, and the slide transfer/eccentricity follow-up mechanism 40 are disposed to implement the track servo on the recording/reproducing laser beam (and gap servo laser beam) and the slide servo of the entire optical pickup OP.

The slide transfer/eccentricity follow-up mechanism 40 holds the optical pickup OP to be displaceable in the tracking direction.

For example, the slide transfer/eccentricity follow-up mechanism 40 is configured to include a power unit having a responsiveness faster than that of a motor included in a thread mechanism installed in an optical disc system of the related art such as a CD, a DVD, and a BD, and displaces the optical pickup OP not only to perform the slide transfer during seeking but also to suppress lens shift occurring due to the disc eccentricity when the tracking servo is in an on state.

In the present example, the slide transfer/eccentricity follow-up mechanism 40 includes a linear motor, and is configured to apply driving force generated by the linear motor to a mechanism unit that holds the optical pickup OP to be displaceable in the tracking direction.

Here, in the recording/reproducing apparatus of the present embodiment, the entire optical pickup OP is driven to follow even disc eccentricity because a system using the objective lens OL including the hyper lens portion L2b as in the present embodiment is considered to be relatively narrower in a range of vision than a BD system or an SIL system of the related art.

The tracking servo circuit 43 includes a first tracking servo signal generating system configured with an HPF 44 and a servo filter 45 and a second tracking servo signal generating system configured with an LPF 46 and a servo filter 47.

The first tracking servo signal generating system corresponds to the tracking direction actuator 10 side that holds the objective lens OL, and the second tracking servo signal generating system corresponds to the slide transfer/eccentricity follow-up mechanism 40 side that holds the optical pickup OP.

In the tracking servo circuit 43, the tracking error signal TE is bifurcated and input to a high pass filter 44 and a low pass filter 46.

The HPF 44 extracts a component equal to or more than a predetermined cutoff frequency from the tracking error signal TE, and outputs the extracted component to the servo filter 45.

The servo filter 45 calculates a servo calculation based on the output signal of the HPF 44, and generates a first tracking servo signal TS-1.

Further, the LPF 46 extracts a component equal to or less than a predetermined cutoff frequency from the tracking error signal TE, and outputs the extracted component to the servo filter 47.

The servo filter 47 calculates a servo calculation based on the output signal of the LPF 46, and generates a second tracking servo signal TS-2.

The first tracking driver 48 drives the tracking direction actuator 10 by a first tracking drive signal TD-1 generated based on the first tracking servo signal TS-1.

Further, the second tracking driver 49 drives the slide transfer/eccentricity follow-up mechanism 40 by a second tracking drive signal TD-2 generated based on the second tracking servo signal TS-2.

Further, the tracking servo circuit 43 is configured to turn on the tracking servo loop in response to an instruction from a controller 57 which will be described later, and to apply an instruction signal for track jumping or seek movement to the first tracking driver 48 or the second tracking driver 49.

Here, in the tracking servo circuit 43, the cutoff frequency of the LPF 46 is set to a frequency equal to or more than a disc eccentricity period (a period at which a positional relation between an optical spot position and a track position changes with the disc eccentricity). Thus, the slide transfer/eccentricity follow-up mechanism 40 can drive the optical pickup OP to follow the disc eccentricity.

In other words, as a result, a lens shift amount of the objective lens OL caused by the disc eccentricity can be considerably suppressed, and the recording/reproducing laser beam and the gap servo laser beam can be prevented from being deviated from the range of vision (the whole width of vision) of the hyper lens portion L2b. In other words, it is possible to prevent the occurrence of a situation in which the laser beam deviates from the range of vision of the hyper lens portion L2b due to the disc eccentricity and so it is difficult to perform recording/reproducing, servo control, or the like.

The address decoder 50 detects the address information recorded by wobbling of the track Tr based on the wobbling signal WS supplied from the signal generating circuit 42. As described above, the address detection is performed by demodulating the address information signal recorded by modulation of the wobbling frequency of the track Tr.

Address information ADR detected by the address decoder 50 is supplied to the necessary components such as the controller 57.

A relative speed synchronous signal obtained by dividing the dot clock Dclk through the divider 51 is input to the speed control unit 52. Here, the relative speed synchronous signal refers to a signal synchronized with the signal (the wobbling signal WS) representing the relative speed between the optical disc D and the optical spot formed on the optical disc D. In other words, the relative speed synchronous signal is a signal which is a target of a phase comparison with a reference frequency signal representing a target rotating speed when the relative speed control is implemented.

As described above, in the optical disc D according to the present embodiment, the wobbling frequency (the central frequency) of the track Tr is set to 1/n of the forming period of the dots DT (that is, the frequency of the dot clock Dclk). Thus, the divider 51 is configured to divide the dot clock Dclk into 1/n frequencies. Through this operation, the relative speed synchronous signal is obtained.

The speed control unit 52 includes an internal oscillator, and generates a driving signal SD used to rotationally drive the optical disc D at a constant speed based on a result of performing a phase comparison between the reference frequency signal output from the oscillator and the relative speed synchronous signal input from the divider 51.

The spindle motor 30 is rotationally driven by the driving signal SD generated by the speed control unit 52. Through this operation, the relative speed control between the optical disc D and the optical spot formed on the optical disc D is implemented. Specifically, in this case, constant linear speed control is implemented.

Further, in the recording/reproducing apparatus, the PLL circuit 53 generates the dot clock Dclk based on the RF signal and the wobbling signal WS.

FIG. 12 is a diagram for describing an internal configuration of the PLL circuit 53.

As illustrated in FIG. 12, the PLL circuit 53 includes a binarization circuit 70, an edge phase comparator 71, an adding unit 72, an NCO 73, a divider 74, and a phase comparator 75.

The binarization circuit 70 performs binarization on the RF signal by slicing the RF signal using a predetermined threshold value th (see FIG. 7C).

The edge phase comparator 71 compares a phase of the binary signal of the RF signal obtained by the binarization circuit 70 with a phase of the dot clock Dclk output from the NCO 73, and outputs a phase comparison signal representing a phase difference between the two signals to the adding unit 72.

Here, the dot clock Dclk obtained by the NCO 73 is supplied to the edge phase comparator 71 as described above, and bifurcated and input to the divider 74.

Similarly to the divider 51, the divider 74 is disposed to obtain the relative speed synchronous signal (the signal synchronized with the relative speed between the optical disc D and the optical spot formed on the optical disc D) based on the dot clock Dclk. In other words, the divider 74 is disposed to obtain the relative speed synchronous signal by dividing the dot clock Dclk into 1/n frequencies.

In FIG. 9 and FIG. 12, the divider 51 and the divider 74 are individually disposed for convenience of illustration, but the dividers can be integrated into a common divider when the same relative speed synchronous signal is obtained.

The phase comparator 75 compares a phase of the relative speed synchronous signal from the divider 74 with a phase of the wobbling signal WS (the relative speed signal) supplied from the signal generating circuit 42, and outputs the phase comparison signal representing the phase difference between the two signals to the adding unit 72.

The adding unit 72 adds the phase comparison signal of the edge phase comparator 71 to the phase comparison signal from the phase comparator 75, and outputs the sum to the NCO 73.

Through this operation, a signal in which both a phase error between the edge position actually detected on the dots DT and the edge position of the dot clock Dclk and a phase error (frequency error) between the actually detected relative speed signal and the relative speed synchronous signal generated to be synchronized with the relative speed signal are reflected is input to the NCO 73. In other words, as a result, the NCO 73 absorbs both the edge phase error and the frequency error and generates the dot clock Dclk.

Here, in the present embodiment, a previous value hold type NCO is used as the NCO 73. Specifically, in this case, the NCO 73 is configured to hold the phase of the dot clock Dclk at a timing instructed by a hold instruction signal HS from the controller 57 illustrated in FIG. 9.

The description will now return to FIG. 9.

The dot clock Dclk generated by the PLL circuit 53 is supplied to the divider 51, and supplied to the recording processing unit 54 and the binarization processing unit 56.

Data (recording data) to be recorded on the optical disc D is input to the recording processing unit 54. The recording processing unit 54 generates a recording signal based on input recording data and the dot clock Dclk (which corresponds to the “recording clock” at the time of recording as can be understood from the above-described recording technique) supplied from the PLL circuit 53.

The recording signal generated by the recording processing unit 54 is supplied to the laser driver 55, and the laser driver 55 drives the recording/reproducing laser 1 to emit light by a laser driving signal generated based on the recording signal, and thus data is recorded on the optical disc D.

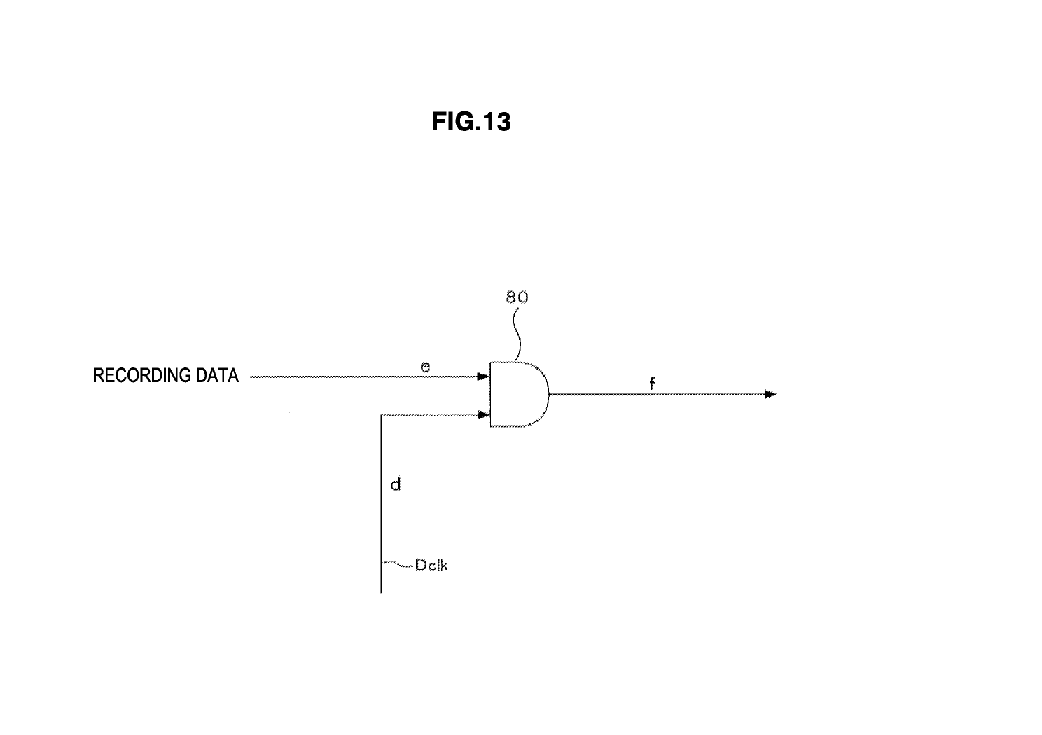

FIG. 13 is a diagram for describing an internal configuration of the recording processing unit 54.

As illustrated in FIG. 13, the recording processing unit 54 includes an AND gate circuit 80 therein. The recording data illustrated in FIG. 9 and the dot clock Dclk (recording clock) from the PLL circuit 53 are input to the AND gate circuit 80. The AND gate circuit 80 performs a logical AND operation on the recording data and the dot clock Dclk, and outputs the logical AND operation result as the recording signal.

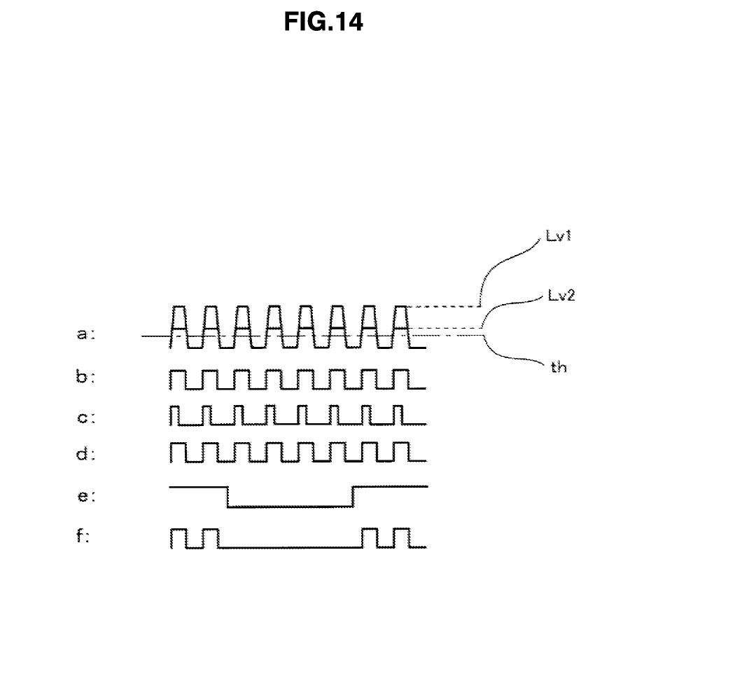

FIG. 14 illustrates a timing chart when the recording signal is generated.

In FIG. 14, “a” represents the RF signal, “b” represents the binary signal generated by the binarization circuit 70 illustrated in FIG. 12, “c” represents an output signal of the adding unit 72, “d” represents the dot clock Dclk (see FIG. 13), “e” represents the recording data (see FIG. 13), and “f” represents an output (the recording signal) of the AND gate circuit 80 (see FIG. 13).

As can be seen from FIG. 14, according to the configuration of the recording processing unit 54 illustrated in FIG. 13, the recording signal capable of applying the recording pulse at the forming position of the dots DT represented by the dot clock Dclk (the recording clock) is obtained. In other words, through this operation, recording can be properly performed on the dots DT on which recording is to be performed.

The description will now return to FIG. 9.

The binarization processing unit 56 performs a binarization process on the RF signal based on the dot clock Dclk.

Specifically, the binarization processing unit 56 performs sampling on the input RF signal at a sampling timing represented by the dot clock Dclk, and thus obtains a binary signal DD representing the recording/non-recording state of the dots DT.

Referring to FIG. 9, the recording/reproducing apparatus is provided with the controller 57 that controls the recording/reproducing apparatus in general.

For example, the controller 57 is configured with a micro computer including a central processing unit (CPU), a read only memory (ROM), a random access memory (RAM), and the like. For example, the controller 57 performs general control by executing a process following a program stored in a memory such as the ROM.

For example, the controller 57 gives a seeking instruction to seek a predetermined address to the tracking servo circuit 43.

Further, the controller 57 instructs the laser driver 55 to emit the recording/reproducing laser beam by reproducing power.

Further, the controller 57 performs control (recording start/stop instruction and the like) of the recording operation performed by the recording processing unit 54.

Particularly, in the present embodiment, the controller 57 also executes a process of implementing the recording technique described with reference to FIG. 6.

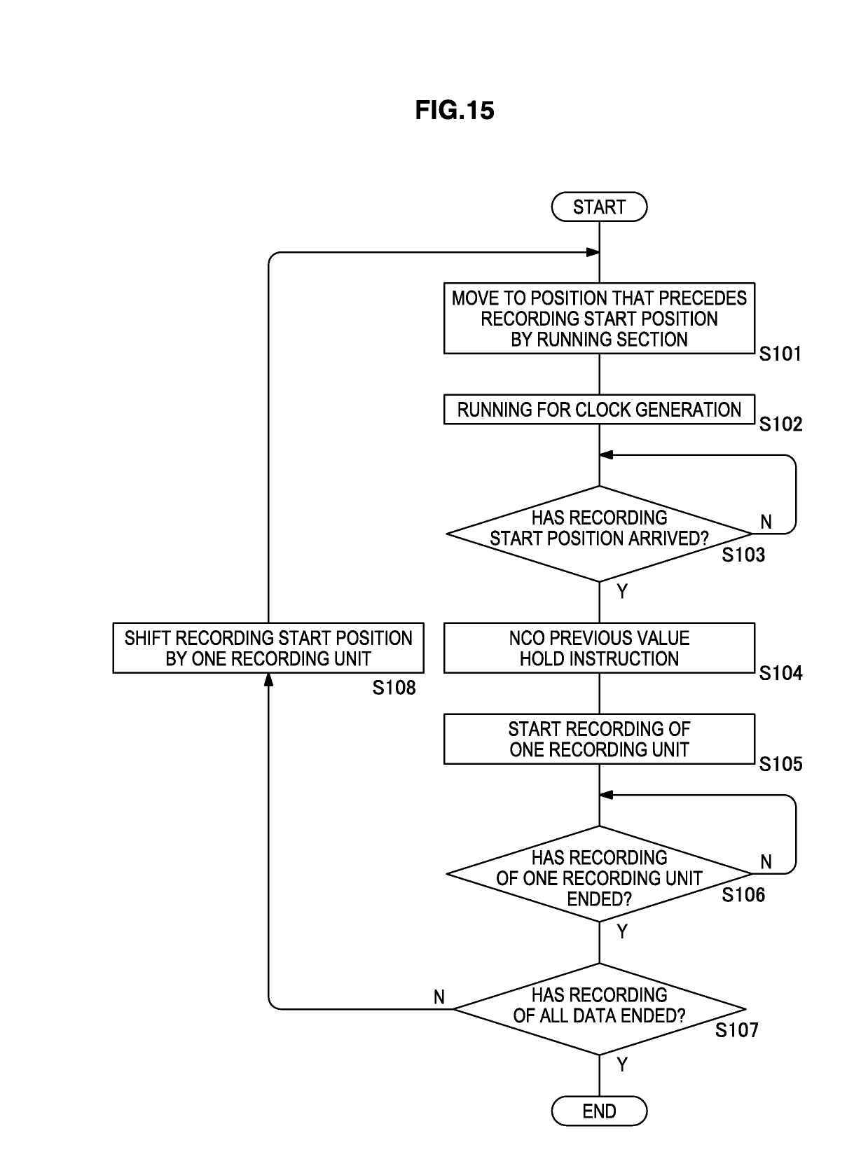

A flowchart of FIG. 15 illustrates a procedure of a concrete process executed to implement the recording technique described with reference to FIG. 6.

The controller 57 executes the process illustrated in FIG. 15 according to a program stored in a predetermined memory such as the ROM.

Referring to FIG. 15, in step S101, a process of moving to the position that precedes the recording start position by the running section is executed.

Here, information representing the section length of the running section for clock generation is set to the controller 57 in advance. The controller 57 instructs the tracking servo circuit 43 to seek the position (address) that precedes the recording start position of the recording data by the running section based on the section length information, and thus a seeking operation to seek the corresponding position is executed.

Then, in step S102, running for clock generation is executed. In other words, in a state in which the laser driver 55 is instructed to cause the recording/reproducing laser 1 to emit light by reproducing power, generation of the dot clock Dclk by the PLL circuit 53 is executed.

Next, in step S103, standby is maintained until the recording start position arrives. In other words, standby is maintained until the recording start position (address) on data to be recorded with reference to the address information ADR from the address decoder 50 arrives.

Then, when the recording start position arrives, in step S104, an NCO previous value hold instruction is given. In other words, the hold instruction signal HS is applied to the NCO 73 to hold the phase state of the dot clock Dclk.

Through this operation, the above-described recording clock is obtained.

Next, in step S105, recording of one recording unit starts. In other words, the recording processing unit 54 is instructed to start data recording of one recording unit. At this time, the recording processing unit 54 generates the recording signal according to the recording clock supplied from the PLL circuit 53.

Subsequently, in step S106, standby is maintained until recording of one recording unit ends.

Then, when recording of one recording unit ends, in step S107, it is determined whether or not recording of all data has ended. In other words, it is determined whether or not recording of all data instructed to be recorded has ended.

In step S107, when recording of all data has not yet ended and thus a negative result is obtained, the process proceeds to step S108, the recording start position is shifted by one recording unit, and then the process returns to step S101. Through this process, running and recording are sequentially executed for each one recording unit described with reference to FIG. 6.

However, when it is determined in step S107 that recording of all data has ended and thus a positive result is obtained, a series of processing operations illustrated in FIG. 15 ends.

Through the above-described configuration of the recording/reproducing apparatus, the recording/reproducing technique of the above-described embodiment is implemented.

[3-3. Example of Concrete Data Recording Format]

Here, in the above description, data to be recorded on the optical disc D is not concretely mentioned. However, concrete data described below may be recorded on the optical disc D in a recording format described below.

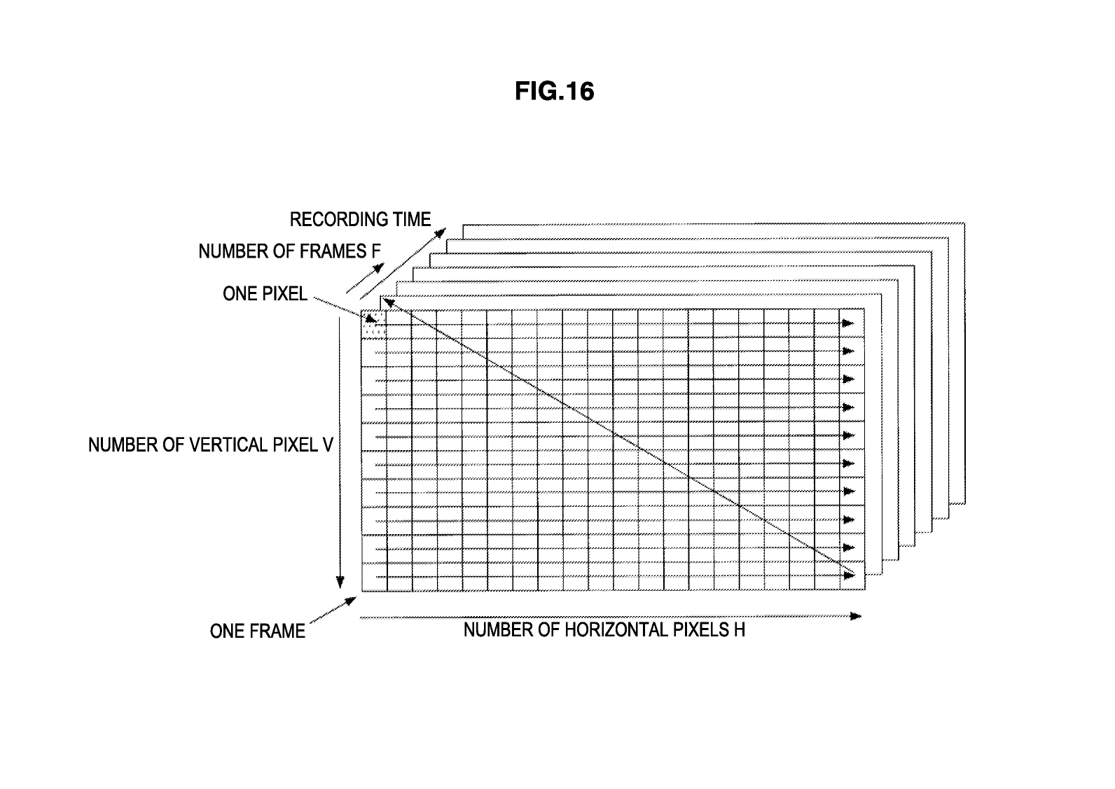

First, moving image data illustrated in FIG. 16 may be assumed to be data to be recorded.

As illustrated in FIG. 16, the moving image data includes consecutive frame image data which each includes the number of horizontal pixels H×the number of vertical pixels V.

Here, data corresponding to one pixel is configured with pixel values (brightness values) of red, green, and blue. In this case, the depth (gradation) of a pixel value is assumed to be 16 bits.

Further, the following format may be used as a recording format corresponding to the moving image data.

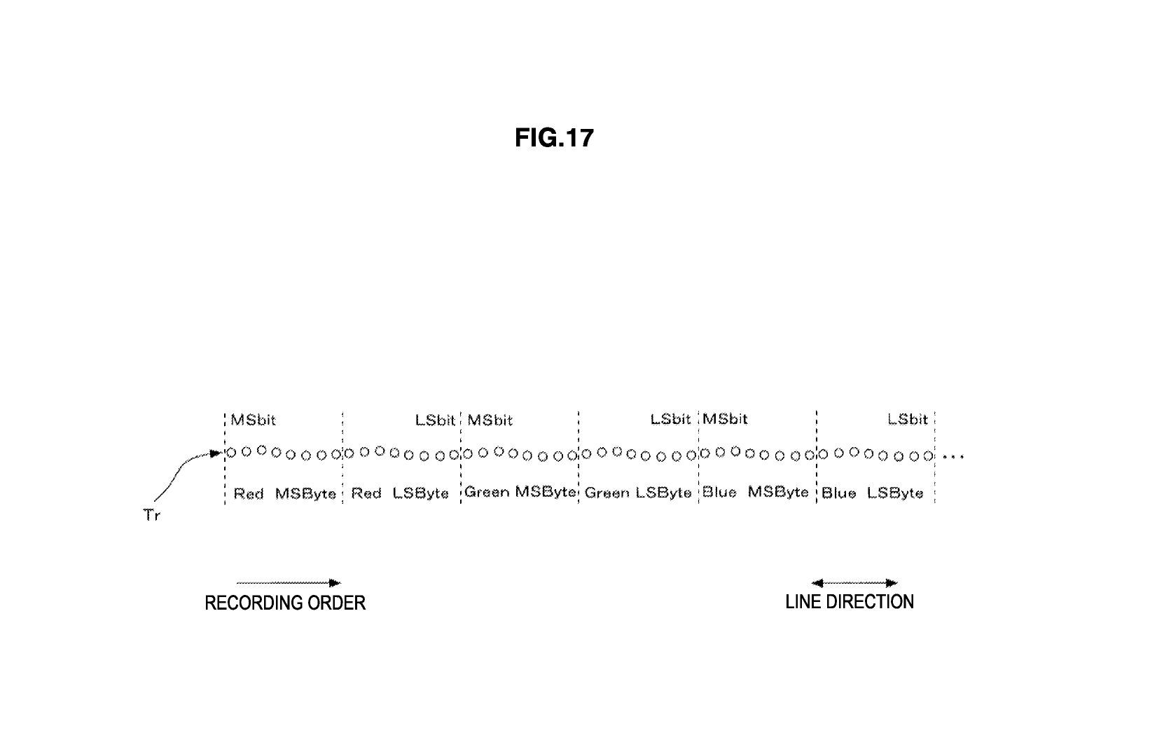

FIG. 17 schematically illustrates an assignment of recording data in a recording format of the present embodiment.

In the recording format in this case, pixel values of R, G, and B colors configuring one pixel are recorded adjacent to one another in the longitudinal direction of the track Tr as illustrated in FIG. 17.

Specifically, in this example, recording is performed in a state in which pixel values of R, G, and B colors configuring one pixel are divided into MSByte and LSByte (that is, divided every 8 bits), and thereafter data of MSByte of an R pixel value, data of LSByte of an R pixel value, data of MSByte of a G pixel value, data of LSByte of a G pixel value, data of MSByte of a B pixel value, and data of LSByte of a B pixel value are arranged in the same order in the longitudinal direction of the track Tr.

As described above, in the recording format of the present embodiment, 48 (=8×6) dots DT on the track Tr are used as one unit to record the pixel values (the pixel values of R, G, and B) of one pixel of the moving image data.

As indicated by an arrow in FIG. 16, recording of data of each pixel is performed such that scanning is performed in order of horizontal lines.

Here, as can be understood from the above description, the recording format in this case is characterized in that raw data of a moving image is recorded on the optical disc D. In other words, raw image data which has not been subjected to recording modulation encoding (run length limited encoding) is recorded on the corresponding dots DT pixel by pixel.

Further, actually, additional data such as an error correction code (ECC) of a predetermined length may be included in units of data corresponding to a predetermined number of pixels. For example, additional data such as an error correction code corresponding to 2048 pixels (12 Kbytes) and address information may be included in units of data corresponding to 8192 pixels (49 Kbytes).

Here, when the above-described recording format is implemented, preferably, data corresponding to one pixel in which the respective values are arranged in order of MSByte of the R pixel value, LSByte of the R pixel value, MSByte of the G pixel value, LSByte of the G pixel value, MSByte of the B pixel value, and LSByte of the B pixel value is sequentially input to the recording processing unit 54 illustrated in FIG. 9 as the recording data.

Further, when additional data such as an error correction code is included, data in which additional data of a predetermined length is included in units of data corresponding to a predetermined number of pixels is preferably input to the recording processing unit 54 as the recording data.

For the sake of confirmation, in the present embodiment, raw data can be directly recorded on the optical disc D without using a modulation code as described above. This is because a pattern medium in which a recording/non-recording (or erasing) state of the dot DT is represented by a code bit such as “0” or “1” is employed as a recording medium, and the reflectance difference is given between the forming portion and the non-forming portion of the dots DT in both of the recording state and the non-recording state of the dots DT, and thus the dot clock Dclk can be properly generated even in a state in which the dots DT in the recording state are mixed with the dots DT in the non-recording state.

In the typical optical disc, when a maximum inversion interval of a recording code is too long, it is remarkably difficult to reproduce a bit clock of a recording code by the PLL. Thus, since it is necessary to reproduce a signal recorded by a combination of a mark (or a pit) and a definite length of space, it is necessary to limit a maximum inversion interval of a recording code. In other words, it is necessary to use a run length limited code as a recording modulation code. However, since raw data has a maximum inversion interval of an infinite length, it is difficult to record raw data as is.

On the other hand, in the present embodiment, since the structure of the pattern medium in which the dots DT are arranged is used, and the reflectance difference is given between the forming portion and the non-forming portion of the dots DT in both of the recording state and the non-recording state of the dots DT, the dot clock Dclk can be properly generated even in a state in which the dots DT in the recording state are mixed with the dots DT in the non-recording state. As a result, a determination of the recording/non-recording state of the dots DT, that is, a determination of a code “0” or “1,” can be properly performed at a timing represented by the dot clock Dclk. For this reason, even if the same code continues, no problem occurs, and it is unnecessary to limit a maximum inversion interval of a recording code.

As a result, according to the present embodiment, a one-to-one correspondence between one dot DT which is a small record carrier and a code 1 bit and a one-to-one correspondence between a physical dot clock and a data bit clock can be implemented, and so pixel raw data of a moving image can be recorded in units of bits in association with one bit on the optical disc D which is a pattern medium.

### <4. Modified Embodiment>

The embodiment of the present application has been described so far, but the present application is not limited to the above-described concrete example.

For example, the above description has been made in connection with the example in which the optical recording medium of the present application has a disk-like external shape. However, the shape of the optical recording medium is not particularly limited, and for example, the optical recording medium may have any other shape such as a rectangular shape

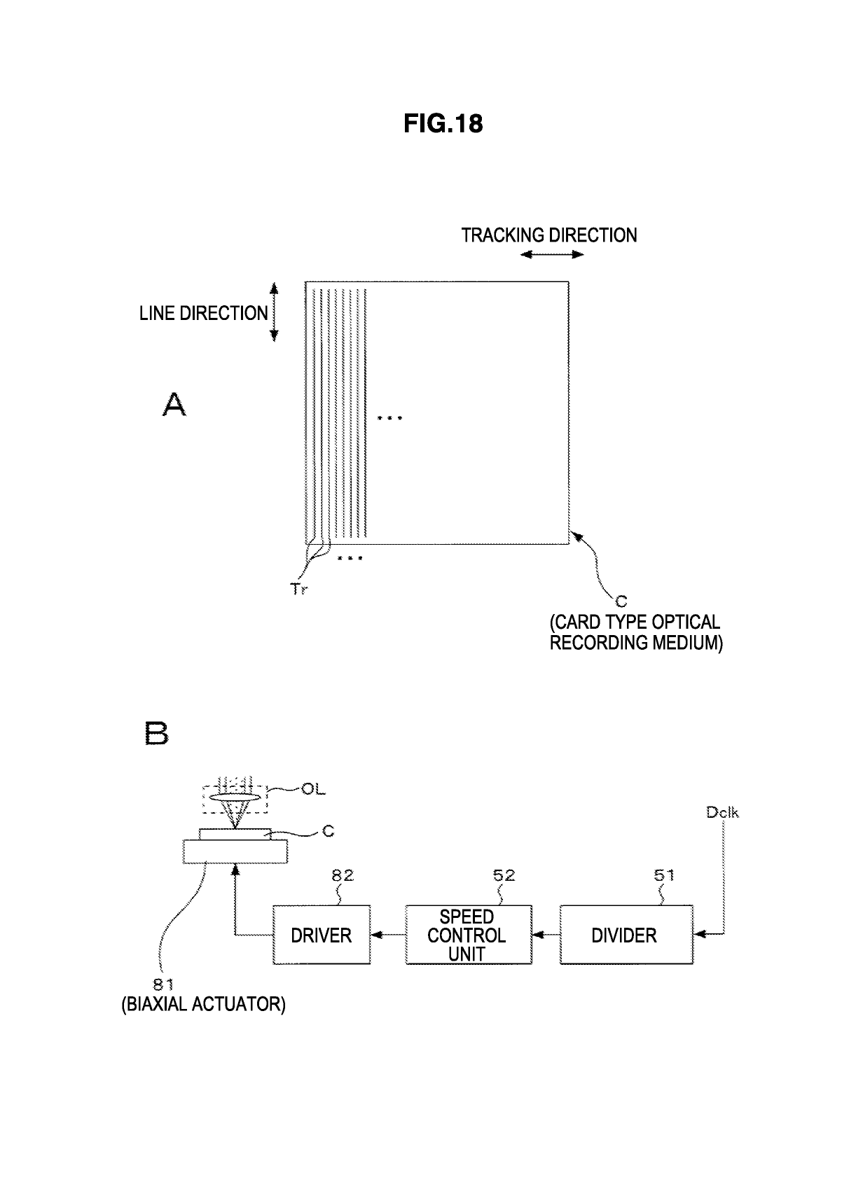

FIG. 18 is a diagram to describe a modified embodiment in which an optical recording medium has a card-like external shape.

FIG. 18A illustrates the structure of a recording surface of a card type optical recording medium C. As illustrated in FIG. 18A, the card type optical recording medium C has a rectangular external shape (a quadrangular shape in this example, and the track Tr is formed in a stripe form on the recording surface thereof. In other words, even in the card type optical recording medium C, similarly to the optical disc D, a plurality of tracks Tr on which the dots DT are arranged in a wobbling manner are arranged adjacent to one another on the recording surface in the tracking direction (a direction orthogonal to the longitudinal direction of the track Tr).

The recording/reproducing apparatus in this case has a configuration illustrated in FIG. 18B to perform recording/reproducing on the card type optical recording medium C in the longitudinal direction (the line direction) of the track Tr.

In FIG. 18B, the same components as the component described above are denoted by the same reference numerals, and the redundant description thereof will not be repeated. In FIG. 18B, mainly, a configuration of a driving system of the card type optical recording medium C and a relative speed control system is selectively illustrated. For example, a configuration of the remaining components including the PLL circuit 53 and the like is the same as the configuration illustrated in FIGS. 8 and 9 and thus is not illustrated.

In the recording/reproducing apparatus in this case, the card type optical recording medium C is driven by the biaxial actuator 81. The biaxial actuator 81 is configured, for example, with a piezo actuator, and can drive the card type optical recording medium C in two directions of the tracking direction and the line direction. The driver 82 drives the biaxial actuator 81 according to a control signal from the speed control unit 52.

As described above, since the card type optical recording medium C can be driven in the two directions orthogonal to each other, recording/reproducing can be performed on the tracks Tr arranged in the tracking direction in the line direction.

In this case, the divider 51 and the speed control unit 52 perform the relative speed control based on the dot clock Dclk, similarly to the configuration illustrated in FIG. 9. Specifically, the speed control unit 52 in this case generates a control signal causing the moving speed of the card type optical recording medium C in the line direction to be a constant speed corresponding to the reference frequency signal based on the relative speed synchronous signal supplied from the divider 51. Then, the control signal is applied to the driver 82, and thus the card type optical recording medium C can be driven in the line direction at a constant speed.

In the above description, generation of the recording clock by running is sequentially performed each time recording of one recording unit is performed as described above with reference to FIG. 6. However, the recording technique of generating the recording clock by running and performing recording is not limited to the technique illustrated in FIG. 6.

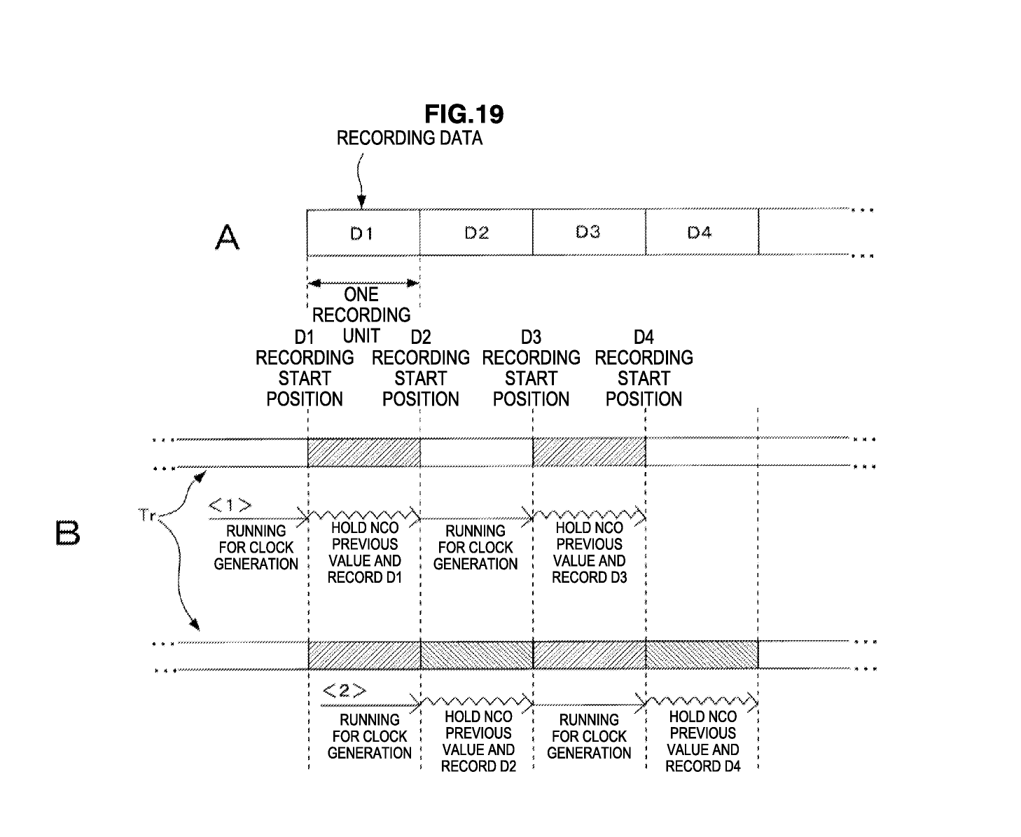

FIG. 19 is a diagram for describing a recording technique according to a modified embodiment.

FIG. 19A schematically illustrates data (recording data) to be recorded on the optical disc D similarly to FIG. 6A, and FIG. 19B schematically illustrates the track Tr similarly to FIG. 6B.

In this case, the concept of one recording unit is the same as in the example of FIG. 6.

In the following description, data instructed to be recorded is referred to as data D1 to data D4 as illustrated in FIG. 19A.

In the recording technique in this case, recording of data of one recording unit is not sequentially performed one by one starting from the data D1 as in FIG. 6. Instead, recording of data of one recording unit is alternately performed (alternately omitted). In a section in which recording is not performed, running for clock generation can be performed, and thus the number of times of the seeking operation is reduced.

Specifically, in the recording technique in this case, as illustrated by <1> of FIG. 19B, running for clock generation is first performed in a preceding section before the recording start position of the data D1 to generate the dot clock Dclk. Thereafter, at a timing at which the recording start position of the data D1 arrives, the phase of the dot clock Dclk is held. Then, the data D1 is recorded from the recording start position of the data D1 using the recording clock obtained by the phase holding. Then, after recording of the data D1 is completed, running for clock generation is performed in the recording section of the data D2. At a timing at which the recording start position of the data D3 arrives, the phase of the dot clock Dclk is held. Then, the data D3 is recorded from the recording start position of the data D3 using the recording clock obtained by the phase holding.

After recording of up to the data D3 is completed, a recording operation represented by <2> is performed. In other words, the recording operation is performed on data (the data D2 and the data D4 in this case) on which recording is not performed during the recording operation of <1>.

Specifically, the recording operation of <2> is as follows. First, running for clock generation is performed in a preceding section before the recording start position of the data D2 to generate the dot clock Dclk. Thereafter, at a timing at which the recording start position of the data D2 arrives, the phase of the dot clock Dclk is held. Then, the data D2 is recorded from the recording start position of the data D2 using the recording clock obtained by the phase holding. Then, after recording of the data D2 is completed, running for clock generation is performed in the recording section of the data D3. At a timing at which the recording start position of the data D4 arrives, the phase of the dot clock Dclk is held. Then, the data D4 is recorded from the recording start position of the data D4 using the recording clock obtained by the phase holding.

In this way, all of the data D1 to the data D4 which need to be recorded are recorded.

As described above, in the recording technique according to the modified embodiment, recording of data of one recording unit is not sequentially performed one by one starting from the data D1. Instead, recording of data of one recording unit is alternately performed (alternately omitted). In a section in which recording is not performed, running for clock generation can be performed. As a result, the seeking operation, which needs to be performed when recording of one recording unit ends in the technique of FIG. 6, is unnecessary, and thus the recording time can be significantly reduced.

Specifically, according to the technique illustrated in FIG. 6, the number of times of the seeking operation necessary to record a series of data instructed to be recorded is equal to the number of pieces of data corresponding to one recording unit included in a series of data. However, according to the recording technique according to the modified embodiment, the seeking operation necessary to record a series of data instructed to be recorded is performed only twice.

Further, the above description has been made in connection with the example in which the present application is applied to the case in which recording/reproducing is performed by the near field method. However, the present application is not limited to the near field method, and can be widely and appropriately applied to general optical recording/reproducing.

The above description has been made in connection with the example in which the small record carrier has a cylindrical shape, but the small record carrier may have a different shape such as a spherical shape.

Further, the above description has been made in connection with the example in which an overall shape of the hyper lens portion L2b is an almost hemispherical shape (a shape that does not fully qualify as a hemispherical shape), but may be a different shape such as a hemispherical shape.

Further, an SIL having a super hemispherical shape has been used as the SIL portion L2a, but an SIL having a hemispherical shape may be used.

Further, the above description has been made in connection with the example in which the optical recording medium has a disk-like shape, and the track Tr is formed in a spiral form. However, the track Tr may be formed in a concentric circular shape.

Additionally, the present application may also be configured as below.

(1) An optical recording medium, comprising:

a plurality of tracks on each of which small record carriers are arranged in a wobbling manner, each of the small record carriers storing a recording state by modulation according to light irradiation,

wherein the tracks are arranged adjacent to each other in a tracking direction which is a direction orthogonal to a longitudinal direction of the tracks, and

there is a reflectance difference between a forming portion and a non-forming portion of the small record carrier in both of a recording state and a non-recording state of the small record carrier.

(2) The optical recording medium according to (1),

wherein the optical recording medium has a disk-like external shape, and the track is formed in a spiral shape or a concentric circular shape.

(3) The optical recording medium according to (1),

wherein the optical recording medium has a rectangular external shape, and the track is formed in a stripe form.

(4) A recording apparatus that performs recording on an optical recording medium that includes a plurality of tracks on each of which small record carriers are arranged in a wobbling manner, each of the small record carriers storing a recording state by modulation according to light irradiation, wherein the tracks are arranged adjacent to each other in a tracking direction which is a direction orthogonal to a longitudinal direction of the tracks, and there is a reflectance difference between a forming portion and a non-forming portion of the small record carrier in both of a recording state and a non-recording state of the small record carrier, the recording apparatus comprising:

a light irradiating/receiving unit that is configured to irradiate recording light and reproducing light to the optical recording medium through an objective lens and to receive reflected light from the optical recording medium;

a tracking servo control unit that generates, based on a light receiving signal obtained by the light irradiating/receiving unit, a tracking error signal representing a position error of an optical spot formed on the optical recording medium by light irradiation by the light irradiating/receiving unit with respect to the track in the tracking direction, and controls a position of the objective lens in the tracking direction based on the tracking error signal;

an address information detecting unit that detects address information recorded by modulation of a wobbling frequency of the track based on the light receiving signal;

a clock generating unit that generates a clock synchronized with a forming period of the small record carrier based on the light receiving signal; and

a control unit that performs control such that the reproducing light is irradiated to the light irradiating/receiving unit in a preceding section before a section of a recording target on the track, a phase of the clock generated by the clock generating unit is then held to obtain a recording clock, and recording is performed on the small record carrier in the section of the recording target at a timing according to the recording clock.

(5) The recording apparatus according to (4), further comprising:

a relative movement driving unit that drives the optical recording medium or the light irradiating/receiving unit such that an optical spot formed on the optical recording medium by the light irradiating/receiving unit relatively moves on the optical recording medium;

a relative speed detecting unit that detects the wobbling frequency of the track based on the light receiving signal, and obtains relative movement speed information of the optical spot; and

a speed control unit that controls the relative movement driving unit based on the relative movement speed information detected by the relative speed detecting unit.

(6) The recording apparatus according to (4) or (5),

wherein a numerical aperture of the objective lens is larger than 1 (one), and recording is performed by a near field method.

(7) The recording apparatus according to (6),

wherein the light irradiating/receiving unit is configured to irradiate different wavelength light having a different wavelength from the recording light and the reproducing light to the optical recording medium through the objective lens and to receive reflected light of the different wavelength light separately from the recording light and the reproducing light, and

the recording apparatus further comprises:

a gap length error signal generating unit that generates a gap length error signal representing an error of a gap length representing a distance between an objective surface of the objective lens and a recording surface of the optical recording medium based on a light receiving signal for the different wavelength light obtained by the light irradiating/receiving unit; and

a gap length control unit that controls the gap length based on the gap length error signal.

(8) The recording apparatus according to (7),

wherein the objective lens includes a hyper lens portion including a first thin film having a negative dielectric constant and a second thin film having a positive dielectric constant that are alternately stacked, and

the light irradiating/receiving unit is configured to irradiate the recording light, the reproducing light, and the different wavelength light to the optical recording medium through the hyper lens portion.

(9) The recording apparatus according to any one of (4) to (8),

wherein one bit of data which has not been subjected to run length limited coding is recorded on each small record carrier.

(10) The recording apparatus according to (9),

wherein image data in which data of one pixel contains pixel values of red, green, and blue is sequentially supplied as recording data for the optical recording medium, and pixel values of red, green, and blue corresponding to one pixel are recorded adjacent to one another in the longitudinal direction of the track.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical recording medium, comprising:
a plurality of tracks on each of which small record carriers are arranged in a wobbling manner, each of the small record carriers storing a recording state by modulation according to light irradiation,
wherein the tracks are arranged adjacent to each other in a tracking direction which is a direction orthogonal to a longitudinal direction of the tracks, and
there is a reflectance difference between a forming portion and a non-forming portion of the small record carrier in both of a recording state and a non-recording state of the small record carrier.

2. The optical recording medium according to claim 1,
wherein the optical recording medium has a disk-like external shape, and the track is formed in a spiral shape or a concentric circular shape.

3. The optical recording medium according to claim 1,
wherein the optical recording medium has a rectangular external shape, and the track is formed in a stripe form.

4. A recording apparatus that performs recording on an optical recording medium that includes a plurality of tracks on each of which small record carriers are arranged in a wobbling manner, each of the small record carriers storing a recording state by modulation according to light irradiation, wherein the tracks are arranged adjacent to each other in a tracking direction which is a direction orthogonal to a longitudinal direction of the tracks, and there is a reflectance difference between a forming portion and a non-forming portion of the small record carrier in both of a recording state and a non-recording state of the small record carrier, the recording apparatus comprising:
a light irradiating/receiving unit that is configured to irradiate recording light and reproducing light to the optical recording medium through an objective lens and to receive reflected light from the optical recording medium;
a tracking servo control unit that generates, based on a light receiving signal obtained by the light irradiating/receiving unit, a tracking error signal representing a position error of an optical spot formed on the optical recording medium by light irradiation by the light irradiating/receiving unit with respect to the track in the tracking direction, and controls a position of the objective lens in the tracking direction based on the tracking error signal;
an address information detecting unit that detects address information recorded by modulation of a wobbling frequency of the track based on the light receiving signal;
a clock generating unit that generates a clock synchronized with a forming period of the small record carrier based on the light receiving signal; and
a control unit that performs control such that the reproducing light is irradiated to the light irradiating/receiving unit in a preceding section before a section of a recording target on the track, a phase of the clock generated by the clock generating unit is then held to obtain a recording clock, and recording is performed on the small record carrier in the section of the recording target at a timing according to the recording clock.

5. The recording apparatus according to claim 4, further comprising:
a relative movement driving unit that drives the optical recording medium or the light irradiating/receiving unit such that an optical spot formed on the optical recording medium by the light irradiating/receiving unit relatively moves on the optical recording medium;
a relative speed detecting unit that detects the wobbling frequency of the track based on the light receiving signal, and obtains relative movement speed information of the optical spot; and
a speed control unit that controls the relative movement driving unit based on the relative movement speed information detected by the relative speed detecting unit.

6. The recording apparatus according to claim 4,
wherein a numerical aperture of the objective lens is larger than 1 (one), and recording is performed by a near field method.

7. The recording apparatus according to claim 6,
wherein the light irradiating/receiving unit is configured to irradiate different wavelength light having a different wavelength from the recording light and the reproducing light to the optical recording medium through the objective lens and to receive reflected light of the different wavelength light separately from the recording light and the reproducing light, and
the recording apparatus further comprises:
a gap length error signal generating unit that generates a gap length error signal representing an error of a gap length representing a distance between an objective surface of the objective lens and a recording surface of the optical recording medium based on a light receiving signal for the different wavelength light obtained by the light irradiating/receiving unit; and
a gap length control unit that controls the gap length based on the gap length error signal.

8. The recording apparatus according to claim 7,
wherein the objective lens includes a hyper lens portion including a first thin film having a negative dielectric constant and a second thin film having a positive dielectric constant that are alternately stacked, and
the light irradiating/receiving unit is configured to irradiate the recording light, the reproducing light, and the different wavelength light to the optical recording medium through the hyper lens portion.

9. The recording apparatus according to claim 4,
wherein one bit of data which has not been subjected to run length limited coding is recorded on each small record carrier.

10. The recording apparatus according to claim 9,
wherein image data in which data of one pixel contains pixel values of red, green, and blue is sequentially supplied as recording data for the optical recording medium, and pixel values of red, green, and blue corresponding to one pixel are recorded adjacent to one another in the longitudinal direction of the track.

11. A recording method of performing recording on an optical recording medium that includes a plurality of tracks on each of which small record carriers are arranged in a wobbling manner, each of the small record carriers storing a recording state by modulation according to light irradiation, wherein the tracks are arranged adjacent to each other in a tracking direction which is a direction orthogonal to a longitudinal direction of the tracks, and there is a reflectance difference between a forming portion and a non-forming portion of the small record carrier in both of a recording state and a non-recording state of the small record carrier, the recording method comprising:
generating, based on a light receiving signal obtained by a light irradiating/receiving unit that is configured to irradiate recording light and reproducing light to the optical recording medium through an objective lens and to receive reflected light from the optical recording medium, a tracking error signal representing a position error of an optical spot formed on the optical recording medium by light irradiation by the light irradiating/receiving unit with respect to the track in the tracking direction, and controlling a position of the objective lens in the tracking direction based on the tracking error signal;
detecting address information recorded by modulation of a wobbling frequency of the track based on the light receiving signal;
generating a clock synchronized with a forming period of the small record carrier based on the light receiving signal; and
performing control such that the reproducing light is irradiated to the light irradiating/receiving unit in a preceding section before a section of a recording target on the track, a phase of the clock generated by the generating of the clock is then held to obtain a recording clock, and recording is performed on the small record carrier in the section of the recording target at a timing according to the recording clock.
